(19) United States
(12) Patent Application Publication
(10) Pub. No.: US 2014/0302826 A1
(43) Pub. Date: Oct. 9, 2014

(54) MOBIL TERMINAL,DATA TERMINAL, AND SERVER

(71) Applicant: Ripplex Inc., Tokyo (JP)

(72) Inventors: Norihiko NAONO, Tokyo (JP); Kunihiko OHNAKA, Tokyo (JP); Jumpei YAMAMOTO, Tokyo (JP)

(73) Assignee: Ripplex Inc., Tokyo (JP)

(21) Appl. No.: 14/243,947

(22) Filed: Apr. 3, 2014

Related U.S. Application Data
(63) Continuation of application No. PCT/JP2011/072808, filed on Oct. 3, 2011.

(51) Int. Cl. H04M 7/12; H04M 1/725

(52) U.S. Cl. CPC H04M 7/1235; H04M 1/72561; H04W 88/06
USPC 455/414.1

(57) ABSTRACT

A mobile terminal is provide including a first sending and receiving means for communicating with a server via a first network, a second sending and receiving means for communicating with the server via a second network having a slower speed than the first network, an imaging means, and a display The imaging means generates first real image data, first summary image data is generated from the first real image data, the second sending and receiving means sends the first summary image data to a data terminal, the second sending and receiving means receives second summary image data generated from second real image data generated by the data terminal, the second summary image data is stored in the memory card and the display simultaneously performs a first image display for expressing the first real image data and a second image display for expressing the second summary image data.

### CROSS REFERENCE TO RELATED APPLICATIONS

This application is a continuation application under 35 U.S.C. §111(a), of International Application PCT/JP2011/072808 filed Oct. 3, 2011, designating the U.S., the entire contents of which are incorporated herein by reference.

### FIELD

The present invention is related to a mobile terminal, a data terminal, and a server. In particular, the present invention is related to a mobile terminal that can collectively use and browse image data stored in various locations, and send them to a Web service using both the mobile terminal and the data terminal.

### BACKGROUND

Various mobile terminals such as mobile phones, tablet devices, and mobile game devices have a wireless communication function and an imaging function. In particular, in recent years, smart phones arranged with large display devices and touch sensors and including a flexible user interface with display large amounts of data have spread rapidly. As a result, a large number of images have been taken using mobile terminals such as smart phones including a wireless communication function. Actually, it is known that many users take images using both camera and mobile phones.

Images taken by a mobile terminal having a wireless communication function such as a smart phone are stored in a storage means in the mobile terminal or a storage medium such as a micro SD card, and are viewed using a display means in the mobile terminal. Furthermore, images taken by a mobile terminal may also be sent to a Web service provided on the Internet using a wireless communication function. For example, users can post an image taken by smart phones directly SNS (Social Networking Service) using the wireless communication function or back up the images to a storage service connected to the Internet.

On the other hand, image data taken by a digital camera is stored in a storage medium having non-volatile semiconductor memory such as an SD card or CompactFlash (registered trademark) that can be attached to the camera. Furthermore, a user connects the memory card in which images are stored to a data terminal such as a personal computer, and copies and stores an image to one data terminal and browses the image using the display means of the data terminal. Because many cameras do not have a communication function, images taken by a camera are often sent to the Internet after first being copied to the data terminal.

Mobile phones are carried around much more often than cameras. For this reason, when a user uses both a mobile terminal having an imaging capability and a camera, the number of images taken by a single user increases much more than those taken using only a camera. Furthermore, in recent years, with the miniaturization of semiconductor technology, the memory capacity of a storage medium such as a memory card used digital cameras has increased, which has led to the number of images taken increasing. A camera user can select just good images and store them by taking a large amount of images and organizing them later without having to worry about costs and limitations of the storage capacity.

Under such circumstances, the situation arises whereby a large amount of image data taken by a user using both a digital camera and a mobile terminal having a wireless communication function becomes dispersed and stored in memory cards attached to a camera, mobile terminals such as a mobile phone, data terminals such as a personal computer and Web services.

Therefore, regardless of the storage location of the image data distributed and stored by a user, the demand for browsing, using and sending to a Web service the image data using both a mobile terminal and data terminal arises. For example, viewing an image taken by a camera together with an image taken using a smartphone, or reversely viewing a high quality image taken using a smart phone together with an image taken using a camera on a personal computer is one example of this demand.

### PRIOR ART DOCUMENTS

### Patent Documents

Patent Document 1: JP 4251757 B
Patent Document 2: JP 3664203 B
Patent Document 3: JP 2003-283900 A
Patent Document 4: JP 2010-178360 A

### SUMMARY OF THE INVENTION

### Problems to be Solved

In order to browse, use, and send to a Web service etc., image data dispersed and stored in various storage locations by a user using both a mobile terminal and a data terminal, methods such as copying images across storage locations or centralized storage of image data on a server have been adopted. However, these methods have the following five problems.

The first problem is that the copy operation is complicated. For example, all images taken using a mobile phone are copied to a personal computer and reversely, all images taken by a digital camera and stored in a plurality of memory cards are copied to a mobile phone, which is complicated copy operation. In particular, in the case of taking a large number of images using both a digital camera and a mobile phone, this problem becomes serious. In addition, for example, in the case of using a communication function of a mobile phone and submitting an image taken by a camera outside to a Web service such as SNS, it is necessary to copy the image taken by the camera to the mobile phone. However, it is often the case that it is not possible to connect a memory card which can be attached and removed to and from a digital camera to a mobile phone. Therefore, an operation such as submitting an image taken by a camera to a Web service after it is copied to a personal computer once has become necessary.

Since transfer of image data by a camera to the Internet taken is more complicated than a mobile terminal having a wireless communication function such as a smart phone, connecting a memory card or a digital camera directly to the internet has been proposed (for example, see Patent Document 1, Patent Document 2, and Patent Document 3). Furthermore, a proposal to store the taken image data in a memory card of an imaging terminal or selecting or setting to upload the image data to a server on a network directly is disclosed (for example, see Patent Document 4). Any of these previous attempts are intended to establish a communication path for copying, the copy operation was not necessarily required and therefore a user was free from the complexity of the copy operation.

The second problem is that the maintaining consistency between storage locations becomes difficult by the copy operation. A large number of images taken by a single user end up being scattered across a plurality of memory cards, mobile terminals, and servers after copy operations, and maintenance of consistency of data between each storage location is difficult. For example, it is difficult for a user with thousands of images to maintain a state where all the images taken by the previous camera can be browsed at all times on a display unit of a mobile terminal is difficult due to the copy operation. In addition, when an image taken with a camera is copied to a personal computer and the copy operation is performed of the same image again after having forgotten this operation, the same image data of the two images end up being stored in the personal computer.

The third problem is that the storage capacity of a mobile terminal is not large enough to store all image data for many users. Therefore, in order to view and use an image taken by a camera on a mobile terminal such as a smart phone, an image is taken using the camera and a part of the image data stored in a memory card or a personal computer is copied to the mobile terminal. It is often the case that an image to be viewed using a mobile terminal is not stored in a mobile phone using this operation. In addition, when a part of the image data is copied to the mobile terminal, the problem of consistency of the image data mentioned above as the second problem increases the difficulty.

The fourth problem is that transfer of images between terminals using wireless communication has many restrictions with regards to where a network can be used and how large its transfer rate is. For example, there are many places where a so-called 3G network of a mobile phone can be used and by copying or uploading image data between the data terminal to a server using the network, it is possible to immediately synchronize image data between a mobile terminal, an information terminal, and a server. However, since the communication line of a mobile phone such as a 3G line is slow, a lot of time is necessary for transferring a large amount of image data. Consequently, a method of not using a line of a mobile phone for transferring image data or uploading to a server is used either by direct connection of a mobile terminal to a local area network or via high-speed wireless communications such as Wi-Fi. Although it is possible to save transfer time, the places where local area networks or Wi-Fi communications can be used is severely limited in comparison with a 3G network, and the immediacy of linking image data between a mobile phone, an information terminal, and a server is significantly impaired. In the conventional method it is impossible to eliminate this trade-off.

The fifth problem is that transferring the image data presses a mobile communication line having a limited bandwidth. With the rapid spread of smart phones, browsing the Web and sending and receiving image data has increased significantly. As a result, the bandwidth of mobile phone lines such as 3G which are operated by a mobile communication operator becomes insufficient and the mobile network operator may not be able to maintain the line infrastructure under a flat rate scheme for users. Consequently, mobile communication operators shift to pay-per-use for the amount of communication data from the flat rate and are setting limits on the total amount of data transfer via a 3G network from a smartphone. However, this has made the first to fourth problems described above more sever and a fundamental solution of all of these problems is an urgent need.

The sixth problem is that the cost of managing a server is increased in the case of centralized management of image data using a server. As described above, one conventional method for storing with consistently a large amount of image data stored in both a mobile terminal and data terminal and also browse and use the image data on both terminals centrally stores the image data in advance in a server. Regardless of low-speed lines such as 3G or high-speed lines such as local area networks or Wi-Fi, it is possible to view and use all image data via a Web browser on both the mobile terminal and information terminal. However, a problem of centralized management by such a server is that when a large amount of image data taken by a user with a camera and a mobile terminal is all stored in a server, the cost for the server maintenance is increased and a burden on the user occurs. For example, as in Non-Patent Document 3, when image data that exceeds a certain storage amount is stored in a server, most Web services require the user to bear the cost and this prevents the spread of centralized management of the images by the server.

The present invention has been made in view of such circumstances and provides a mobile terminal, a data terminal, a server, a memory card system, and a method whereby after having taken images using a plurality of imaging terminals such as a mobile phone or a camera, the image data stored in various location such as a mobile phone, a memory card, a data terminal and a personal computer, it is possible to collectively use, browse and send the image data to a the Web service using both the mobile terminal and data terminal.

### Means for Solving the Problems

As one embodiment of the present invention, a mobile terminal comprising: a first sending and receiving means configured to communicate with a server via a first network; a second sending and receiving means configured to communicate with the server via a second network having a slower speed than that of the first network; an imaging means; and a display means; wherein the imaging means generates a first real image data; the first real image data is stored in a memory card; a first summary image data is generated from the first real image data; the second sending and receiving means sends via the second network and the server the first summary image data to a data terminal configured to communicate with the server; the second sending and receiving means receives, via the second network and the server from the data terminal storing a second real image data, a second summary image data generated from the second real image data by the data terminal; the second summary image data is stored in the memory card; and the display means simultaneously performs a first image display for expressing the first real image data and a second image display for expressing the second summary image data.

As one embodiment of the present invention, a mobile terminal comprising: a first sending and receiving means configured to communicate with a server via a first network; a second sending and receiving means configured to communicate with the server via a second network having a slower speed than that of the first network; an imaging means; and a display means; wherein the imaging means generates a first real image data; the first real image data is stored in a memory card; a first summary image data is generated from the first real image data; the second sending and receiving means sends via the second network and the server the first summary image data to a data terminal configured to communicate with the server; the second sending and receiving means receives, via the second network and the server from the data terminal storing a second real image data, a second summary image data generated from the second real image data by the data terminal; the mobile terminal stores the second summary image data; and the display means simultaneously performs a first image display for expressing the first real image data and a second image display for expressing the second summary image data.

As one embodiment of the present invention, a mobile terminal comprising: a first sending and receiving means configured to communicate with a server via a first network; a second sending and receiving means configured to communicate with the server via a second network having a slower speed than that of the first network; an imaging means; and a display means; wherein the imaging means generates a first real image data; the first real image data is stored; a first summary image data is generated from the first real image data; the second sending and receiving means sends via the second network and the server the first summary image data to a data terminal configured to communicate with the server; the second sending and receiving means receives, via the second network and the server, from the data terminal storing a second real image data, a second summary image data generated from the second real image data by the data terminal; the second summary image data is stored; and the display means simultaneously performs a first image display for expressing the first real image data and a second image display for expressing the second summary image data.

As one embodiment of the present invention, a mobile terminal comprising: a first sending and receiving means configured to communicate with a server via a first network; a second sending and receiving means configured to communicate with the server via a second network having a slower speed than that of the first network; an imaging means; and a display means; wherein the imaging means generates first real image data; the first real image data and a first image ID for specifying the first real image data and is stored in a memory card wherein the first real image data and the first image ID are correlated; the first image ID and a memory card ID for specifying the memory card are stored in a table wherein the first image ID the memory card ID are correlated; the mobile terminal generates a first summary image data from the first real image data; the second sending and receiving means sends via the second network and the server the first summary image data to a data terminal configured to communicate with the server; the second sending and receiving means receives, via the server and the second network from the data terminal storing a second real image data, a second image ID for specifying the second real image data and a second terminal ID for specifying the data terminal, and a second summary image data generated from the second real image data by the data terminal; the mobile terminal stores the second summary image data and the second image data in a memory card wherein the second summary image data and the second image data are correlated; and the mobile terminal stores the second real image ID and the second terminal ID in the table wherein the second real image ID and the second terminal ID are correlated.

As one embodiment of the present invention, a mobile terminal comprising: a first sending and receiving means configured to communicate with a server via a first network; a second sending and receiving means configured to communicate with the server via a second network having a slower speed than that of the first network; an imaging means; and a display means; wherein the imaging means generates a first real image data; the first real image data and a first image ID for specifying the first real image data are stored in a first table wherein the first real image data and the first image ID are correlated; the first image ID and a terminal ID for specifying the mobile terminal are stored in a second table wherein the first image ID and the terminal ID are correlated; a first summary image data is generated from the first real image data; the second sending and receiving means sends via the second network and the server the first summary image data to a data terminal configured to communicate with the server; the second sending and receiving means receives via the server and the second network from the data terminal storing a second real image data, a second image ID for specifying the second real image data, a second terminal ID for specifying the data terminal from the data terminal, and a second summary image data generated from the second real image by the data terminal; the second summary image data and the second image data are stored in the first table wherein the second summary image data and the second image data are correlated; the second real image ID and the second terminal ID are stored in the second table wherein the second real image ID and the second terminal ID are correlated.

As one embodiment of the present invention, a server comprising: a sending and receiving means configured to communicate with a first network and a second network having a slower speed than that of the first network; wherein a first summary image data generated from a first real image data imaged by a mobile terminal and stored in a memory card connected to the mobile terminal is received via the second network from the mobile terminal; the first summary image data is stored; the first summary image data is sent to a data terminal via the second network; a second summary image data generated from second real image data stored by the data terminal is received via the second network from the data terminal; the second summary image data is stored; the second summary image data is sent to the mobile terminal via the second network; the first real image data is received via the first network from the mobile terminal; the first real image data is sent to the data terminal via the first network; the second real image data is received via the first network from the data terminal; and the second real image data is sent to the mobile terminal via the first network.

As one embodiment of the present invention, a data terminal comprising: a sending and receiving means capable of communicating with a mobile terminal via a first network, the mobile terminal including a first mobile terminal sending and receiving means communicating with the first network and a second mobile terminal sending and receiving means communicating with a second network having a slower speed than that of the first network; and a display means; wherein a first real image data is stored; a first summary image data is generated from the first real image data; the sending and receiving means sends the first summary image data to the mobile terminal via the first network, the second network, and the second mobile terminal sending and receiving means; the sending and receiving means receives, via the second mobile terminal sending and receiving means the second network, and the first network from the mobile terminal storing a second real image data, a second summary image data generated from the second real image data by the mobile terminal; the second summary image data is stored; and the display means simultaneously performs a first image display for expressing the first real image data and a second image display for expressing the second summary image data.

As one embodiment of the present invention, a system comprising: a data terminal capable of communicating with a first network; a mobile terminal capable of being connected to the first network and a second network having a slower speed than that of the first network; and a server; wherein while the mobile terminal is connected to the second network, the mobile terminal sends a first summary image data generated from a first real image data stored by the mobile terminal to the data terminal via the second network, the server, and the first network; the data terminal stores the first summary image data; a second summary image data generated from a second real image data stored by the data terminal is sent to the mobile terminal by the data terminal via the first network, the server, and the second network; the mobile terminal stores the second summary image data; while the mobile terminal is connected to the first network, the mobile terminal sends the first real image data to the data terminal via the first network; the data terminal stores the first real image data; the data terminal sends the second real image data to the mobile terminal via the first network; and the mobile terminal stores the second real image data.

As one embodiment of the present invention, a mobile terminal comprising; an imaging means; a sending and receiving means capable of communicating with a data terminal via a server and a network; a network speed measurement means; and a display means; wherein the network speed measurement means measures the communication speed of the network by communicating with the server via the sending and receiving means and the network; a first communication speed related data is generated from a first measurement result; the imaging means generates a first real image data; the first real image data is stored; a first summary image data of a first data amount determined according to the first communication speed related data is generated from the first real image data; the first summary image data and the first communication speed related data are stored wherein the first summary image data and the first communication speed related data are correlated; the sending and receiving means sends the first summary image data and the first communication speed related data to the data terminal via the network; the sending and receiving means receives, via the network from the data terminal storing a second real image data, a second summary image data of the first data amount, the second summary image data being generated from the second real image data by the data terminal; and the second summary image data and the first communication speed related data are stored wherein the second summary image data and the first communication speed related data are correlated.

As one embodiment of the present invention, a system comprising: a network; a mobile terminal capable of communicating with the network; and a data terminal capable of communicating with the network; wherein after measuring a network communication speed, the mobile terminal generates a first communication speed related data from a first result of the measurement; the mobile terminal generates an image and stores the image as a first real image data; the mobile terminal generates a first summary image data of a first data amount determined by the first communication speed related data, the first summary image data being generated from the first real image data; the mobile terminal sends the first summary image data and the first communication speed related data to the data terminal via the network; the data terminal stores the first summary image data and the first communication speed related data wherein the first summary image data and the first communication speed related data are correlated; a second summary image data of the first data amount is generated from second real image data stored by the data terminal; the data terminal sends the second summary image data to the mobile terminal; the mobile terminal stores the second summary image data and the first communication speed related data wherein the second summary image data and the first communication speed related data are correlated; a second communication speed related data is generated from a first result of measuring the network communication speed by the mobile terminal; the mobile terminal compares the firs communication speed related data and the second communication speed related data; a third summary image data is generated from the first real image data, the third summary image data being of a second data amount determined by the second communication speed related data, in the case where the second communication speed related data is larger than the first communication speed related data; the mobile terminal sends the third summary image data and the second communication speed related data to the data terminal via the network; the data terminal stores the third summary image data and the second communication speed related data wherein the third summary image data and the second communication speed related data are correlated; the data terminal generates a fourth summary image data of the second data amount from the second real image data; the data terminal sends the fourth summary image data to the mobile terminal via the network; and the mobile terminal stores the fourth summary image data and the second communication speed related data wherein the fourth summary image data and the second communication speed related data are correlated.

As one embodiment of the present invention, a mobile terminal comprising: a sending and receiving means capable of communicating with a first server and a second server via a network; a display means; and a cache table; wherein a first communication speed related data representing the communication speed of the network is received from the first server; the first communication speed related data is stored; a first image list display data including an image display expressing a real image data stored by the second server is received from the first server; the display means displays a first image list generated from the first image list display data; a second communication speed related data which is generated from the real image data and is correlated with a first summary image data which is stored in the cache table is compared with the first communication speed related data; the sending and receiving means sends a request for a second summary image data, the second summary image data being generated from the real image data the second summary image data being of a first data amount corresponding to the first communication speed related data, and the first communication speed related data to the second server wherein the request for the second image data and the first communication speed related data are correlated, in the case where the first communication speed related data is larger than the second communication speed related data; the sending and receiving means receives the second summary image data from the second server; and the cache table stores the second summary image data and the first communication speed related data wherein the second summary image data and the first communication speed related data are correlated.

As one embodiment of the present invention, a mobile terminal comprising: a sending and receiving means capable of communicating with a first server and a second server via a network; a display means; and an image cache table; wherein a first communication speed related data representing the communication speed of a network is received from the first server; the first communication speed related data is stored; a first image list display data including an image display expressing a real image data stored by the second server is received from the first server; the display means displays a first image list generated from the first image list display data; the sending and receiving means sends a request for a second summary image data generated from the real image data, the second summary image data being of a first data amount corresponding to the first communication speed related data, and the first communication speed related data to the second server wherein the request for the second summary image data and the first communication speed related data are correlated, in the case where summary image data generated from the real image data is not stored in the image cache table; the sending and receiving means receives the second summary image data from the second server; and the image cache table stores the second summary image data with the first communication speed related data wherein the second summary image data with the first communication speed related data are correlated.

As one embodiment of the present invention, a mobile terminal comprising: a sending and receiving means capable of communicating with a first server and a second server via a network; a display means; an input means; and a cache table; wherein a first communication speed related data representing the communication speed of the network is received from the first server; the first communication speed related data is stored; a first image list display data including a first image ID is received from the first server; the first communication speed related data and the first image ID are sent to the second server; a first thumbnail data stored by the second server, the first thumbnail being correlated with the first image ID, being of a first data amount, and being generated from the first real image data, the first data amount corresponding to the first communication speed related data, is received from the second server; the display means display a first image list generated from the first image list display data and including the first thumbnail data; a second communication speed related data expressing the communication speed of the network is received from the first server; the second communication speed related is stored; a second image list display data including a second image ID is received from the first server; the second communication speed related data and the second image ID are sent to the second server; a second thumbnail data stored by the second server with the second image ID, the second thumbnail data being correlated with the second image ID, being of a second data amount, and generated from second real image data, the second data amount corresponding to the second communication speed related data, is received from the second server; and the display means displays a second image list generated from the second image list display data and including the second thumbnail data.

### Advantageous Effect of the Present Invention

According to the present invention, after having taken images using a plurality of imaging terminals such as a mobile phone or a camera, the image data stored in various location such as a mobile phone, a memory card, a data terminal, and a personal computer, it is possible to collectively use, browse and send to a Web service the image data using both the mobile terminal and the data terminal. In addition, according to the present invention, by utilizing multiple networks having different communication speeds, the cost for implementing these is reduced compared to conventional methods.

### BRIEF EXPLANATION OF THE DRAWINGS

FIG. 1 is a schematic diagram of an image processing system according to one embodiment of the present invention;

FIG. 2 is a schematic diagram of an image processing system according to one embodiment of the present invention;

FIG. 3 is a schematic diagram of a mobile terminal according to one embodiment of the present invention;

FIG. 4 is a schematic diagram of a data terminal according to one embodiment of the present invention;

FIG. 5 is a schematic diagram of the application server according to one embodiment of the present invention;

FIG. 6 is a schematic diagram of the image distribution server according to one embodiment of the present invention;

FIG. 7 is a schematic diagram of a memory card according to one embodiment of the present invention;

FIG. 8 is a flow diagram of a process according to one embodiment of the present invention;

FIG. 9 is one example of an image data table and image attribute table according to one embodiment of the present invention;

FIG. 10 is one example of a summary image data table and an image attribute table according to one embodiment of the present invention;

FIG. 11 is a one example of an image data table and a table that correlates a real image ID, a real storage location, and a summary image ID according to one embodiment of present invention;

FIG. 12 is a one example of an image list screen according to one embodiment of the present invention;

FIG. 13 is one example of an enlarged display of an image according to one embodiment of the present invention;

FIG. 14 is one example of an enlarged display of an image according to one embodiment of the present invention;

FIG. 15 is one example of a summary image data table and image attribute table and according to one embodiment of the present invention;

FIG. 16 is one example of an image data table and image attribute table according to one exemplary embodiment of the present invention;

FIG. 17 is one example of an image list screen according to one embodiment of the present invention;

FIG. 18 is a flow diagram of a process according to one embodiment of the present invention;

FIG. 19 is a one example of an image data table and an image attribute table according to one embodiment of the present invention;

FIG. 20 is one example of an image display screen according to one embodiment of the present invention;

FIG. 21 is one example of an image display screen according to one embodiment of the present invention;

FIG. 22 is a sequence diagram of a process according to one embodiment of the present invention;

FIG. 23 is a sequence diagram of a process according to one embodiment of the present invention;

FIG. 24 is one example of an image data table, a summary image data table, and an image data table according to one exemplary embodiment of the present invention;

FIG. 25 is one example of an image data table, a summary image data table, and an image data table according to one exemplary embodiment of the present invention;

FIG. 26 is a flow diagram of a process according to one embodiment of the present invention;

FIG. 27 is one example of a real image table and an image attribute table according to one embodiment of the present invention;

FIG. 28 is one example an image list display according to one embodiment of the present invention;

FIG. 29 is one example an am image data table according to one embodiment of the present invention;

FIG. 30 is one example an enlarged display of an image according to one embodiment of the present invention; and

FIG. 31 is one example an enlarged display of an image according to one embodiment of the present invention.

### EMBODIMENTS FOR CARRYING OUT THE PRESENT INVENTION

The best mode presently contemplated for carrying out the present invention is explained below. Since the scope of the present invention is clearly defined by the scope of the appended claims, the scope of the present invention should not be interpreted in a limited since and the explanation below is only intended to merely illustrate the general principles of the invention.

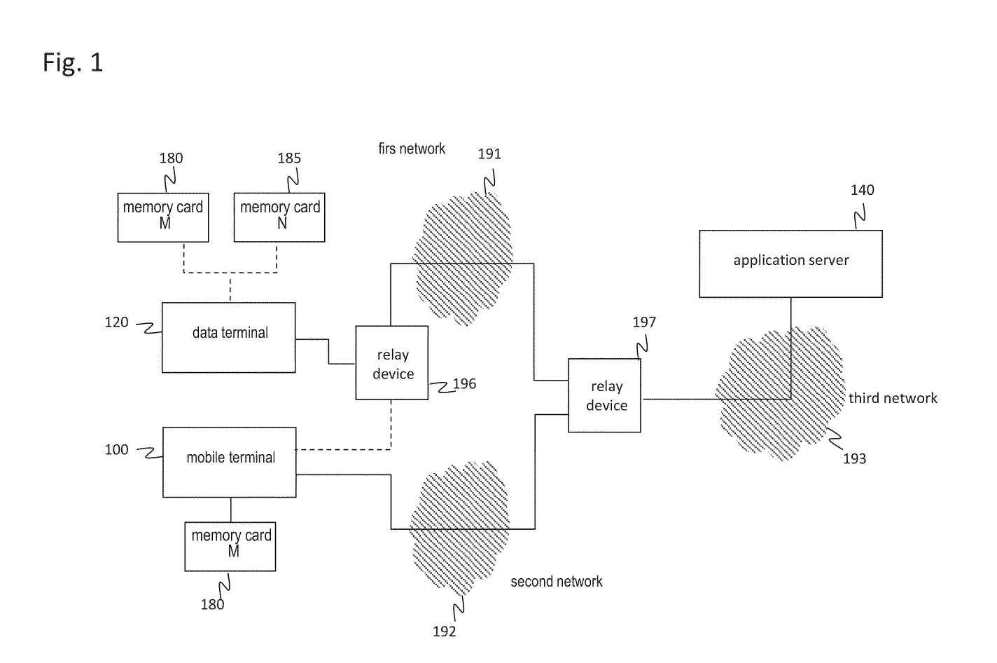

FIG. 1 is a schematic diagram of an image data processing system according to one embodiment of the present invention. The image data processing system shown in FIG. 1 is comprised from a mobile terminal 100, a data terminal 200, a first network and application server 140, a relay device 196, a relay device 197, a first network 191, a second network 192, and a third network 193. The third network 193 is preferred to be capable to communicate at a higher speed than that of the first network 191 and that of the second network 192. In addition, a memory card M180 is connected to the mobile terminal 100. The data terminal 120 includes an attachable memory card input and output means 122 and is connected to either a memory card N185 or a memory card M180. In FIG. 1, the solid line shows a normally connected stated and the dotted line shows both a connected and non-connected state in the process described below. An example of a schematic structure of the image processing system shown in FIG. 1 is used in the first embodiment and second embodiment described below.

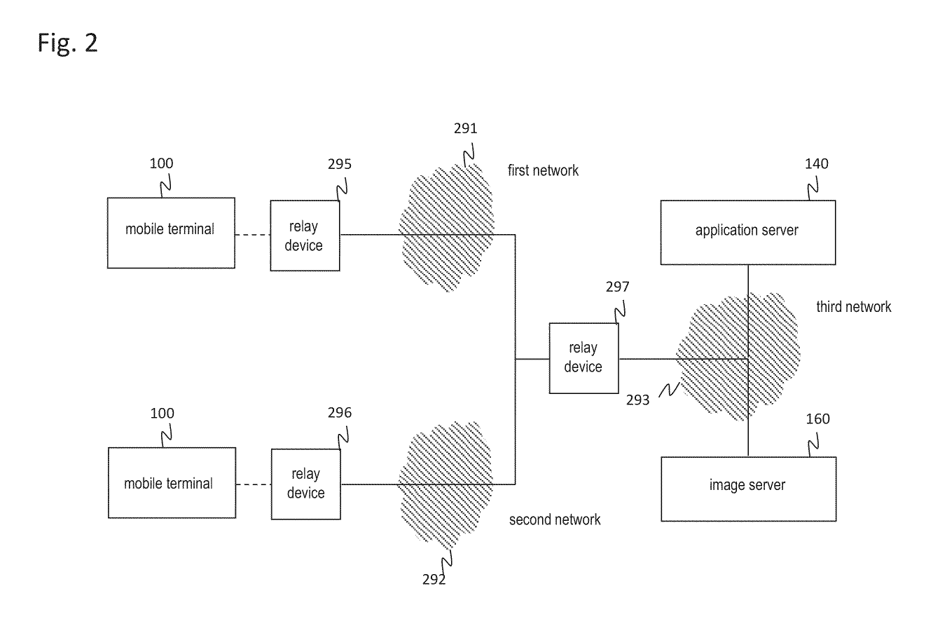

FIG. 2 is a schematic diagram of an image processing system, which is another example of an embodiment of the present invention. In the example of the image processing system shown in FIG. 2, the application server 140 and the image server 160 communicate with the mobile terminal 100 via the third network 293 and the relay device 297 and via the first network 291 or the second network 292. The example of a schematic structure of the image data processing system shown in FIG. 2 is used in the third embodiment described below. Furthermore, the third network 293 is preferred to be capable to communicate at a higher speed than that of the first network 291 and that of the second network 292.

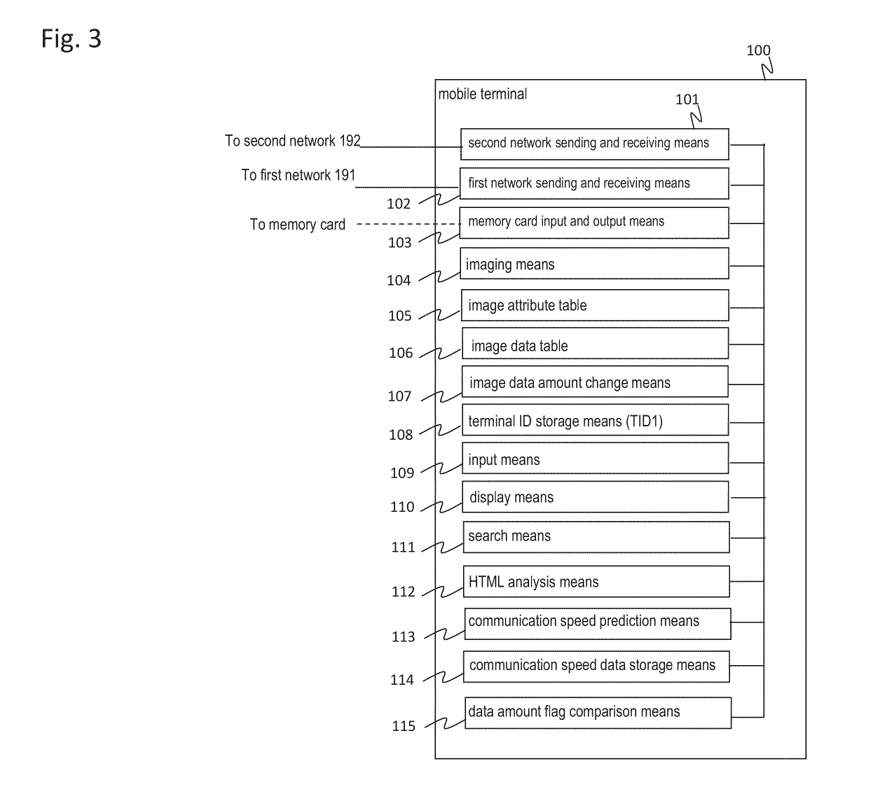

FIG. 3 is an example of a schematic structure of the mobile terminal 100. The mobile terminal 100 includes a second network sending and receiving means 101, a first network sending and receiving means 102, a memory card input and output means 103, an imaging means 104, an image attribute table 105, an image data table 106, an image data amount change means 107, a terminal ID storage means 108, an input means 109, a display means 110, a search means 111, an HTML analysis means 112, a communication speed prediction means 113, a communication speed data storage means 114, and a data amount flag comparison means 115. The first network sending and receiving means 102 is connected to the first network 191 and the second network sending and receiving means 101 is connected to the second network 192. The mobile terminal 100 may be a mobile phone, a personal computer, a camera, or a table type terminal for example. The mobile terminal 100 may or may not include an imaging function. In the case where the mobile terminal 100 does not include an imaging function, image data stored in a memory card may be obtained from the memory card input and output means 103.

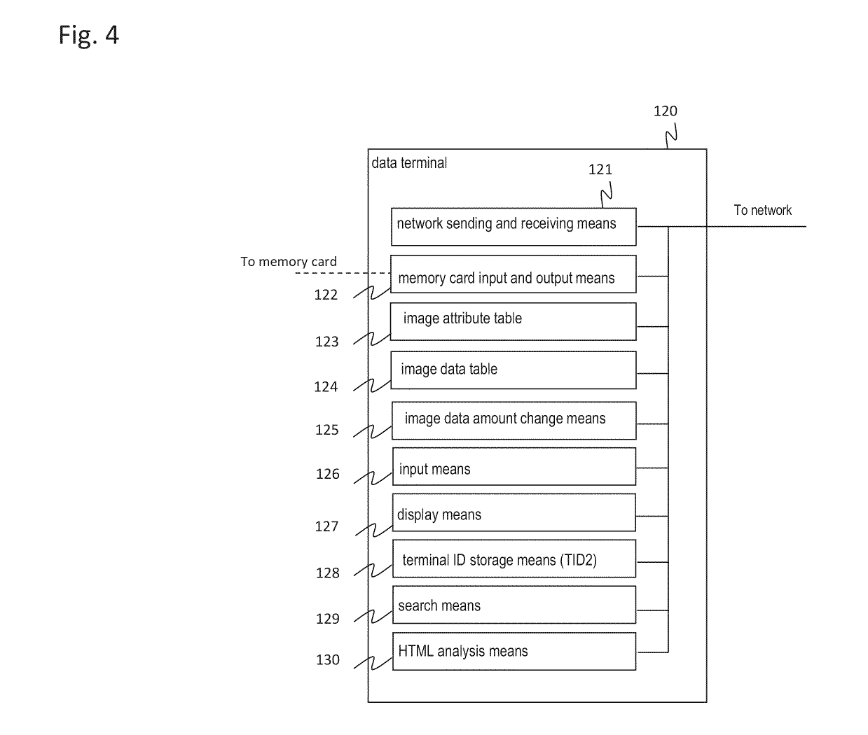

FIG. 4 is an example of a schematic structure of another data terminal 120. A mobile terminal of a user A includes a network sending and receiving means 121, a memory card input and output means 122, an image attribute table 123, an image data table 124, an image data amount change means 125, an input means 126, a display means 127, a terminal ID storage means 128, a search mean 129, and an HTML analysis means 130.

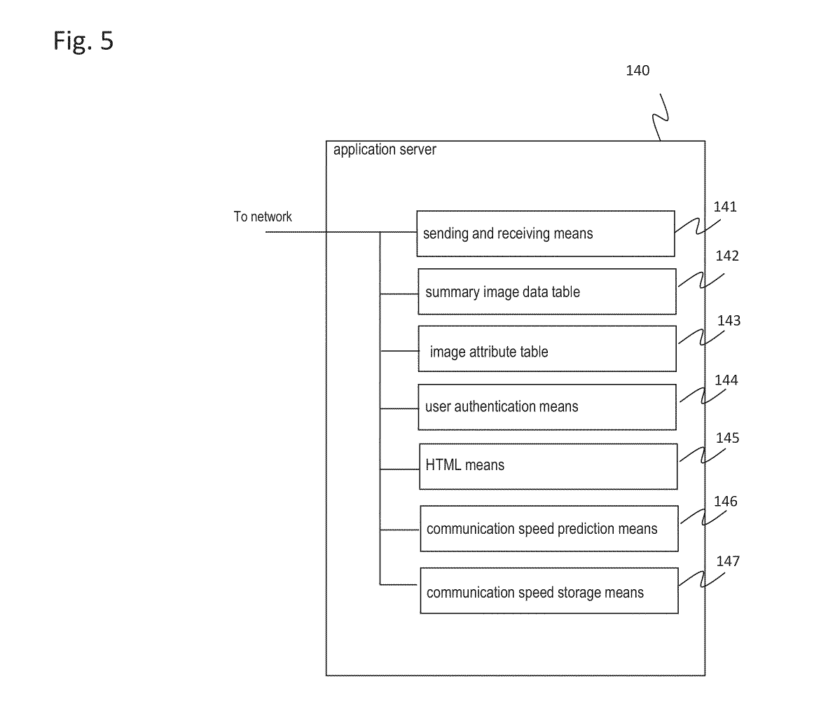

FIG. 5 is an example of a schematic structure of the application server 140. The application server 140 includes a sending and receiving means 141, a summary image table 142, an image attribute table 143, a user authentication means 144, an HTML generation means 145, a communication speed prediction means 146, and a communication speed storage means 147.

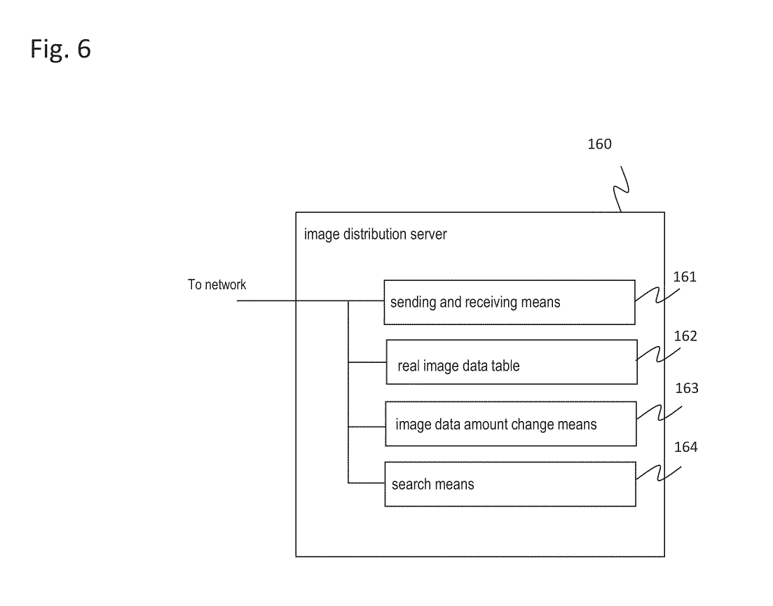

FIG. 6 is an example of a schematic structure of an image server 160. The application server 160 includes a sending and receiving means 161, a real image data table 162, an image data amount change means 163, and a search means 164.

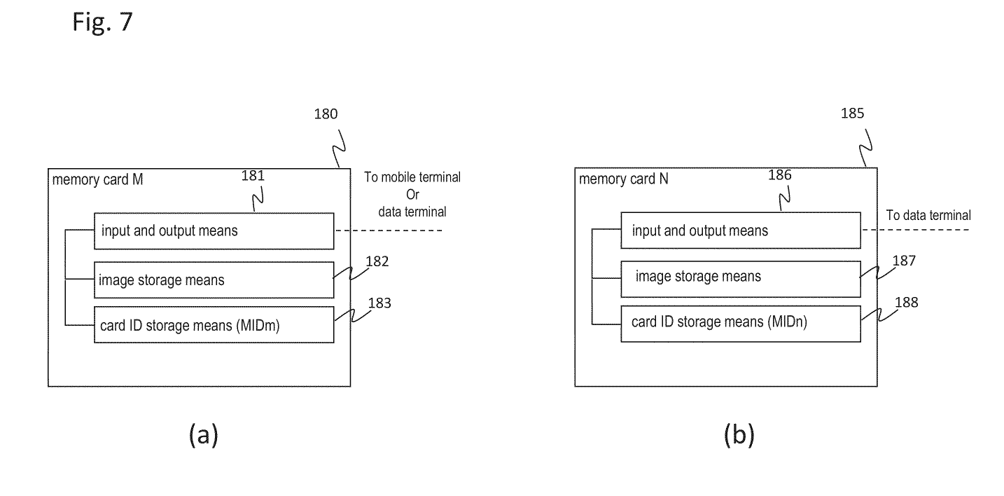

FIG. 7 (a) is an example of a schematic structure of the memory card M180. The memory card M180 includes an input and output means 181, an image storage means 182, and a card ID storage means 183. FIG. 7 (b) is an example of a schematic structure of the memory card N185. The memory card N185 includes an input and output means 186, an image storage means 187 and, a card ID storage means 188.

In the present specification, image data taken by an imaging terminal or a mobile terminal and also stored in a memory card, the mobile terminal, the data terminal or a server is called an original image. In addition, an image obtained by processing an original image is referred to a processed image of that original image. When comparing two images either an original image or a processed image, an image with a larger amount of data is referred to as a real image and a data with a smaller amount of data is referred to as a summary image. For example, when an original image having RAW format is converted to a JPEG (Joint Photographic Experts Group) format image with a smaller amount of data, the original image is a real image and the process image of this original image is a summary image. Furthermore, in the case where two processed images are generated from one original image, the processed image with a large amount of data is a real image and the processed image with a small amount of data is a summary image. If a real image is image data stored in an image storage means of an imaging terminal, for example, the image may be of any image format such as RAW, JPEG, JPEG2000, TIFF (Tagged Image File Format) or GIF (Graphics Interchange Format) specific to that imaging terminal. A summary image may also be of any format such as JPEG, RAW, PNG (Portable Network Graphic), TIFF (Tagged Image File Format) or GIF. In addition, in the present invention, image data may a still image or video. In the case where image data is video, a real image or a summary image may be of any format such as MPEG-1 (Moving Picture Experts Group), MPEG-2, MPEG-4, AVI (Audio Video Interleave) or MOV (Quicktime format). In the description below, regardless of whether an image data is a still image or video, when there are two image data generated from the same original image, the image with the larger amount of data is called a real image and the image with a smaller amount of image data is called a summary image.

### First Embodiment

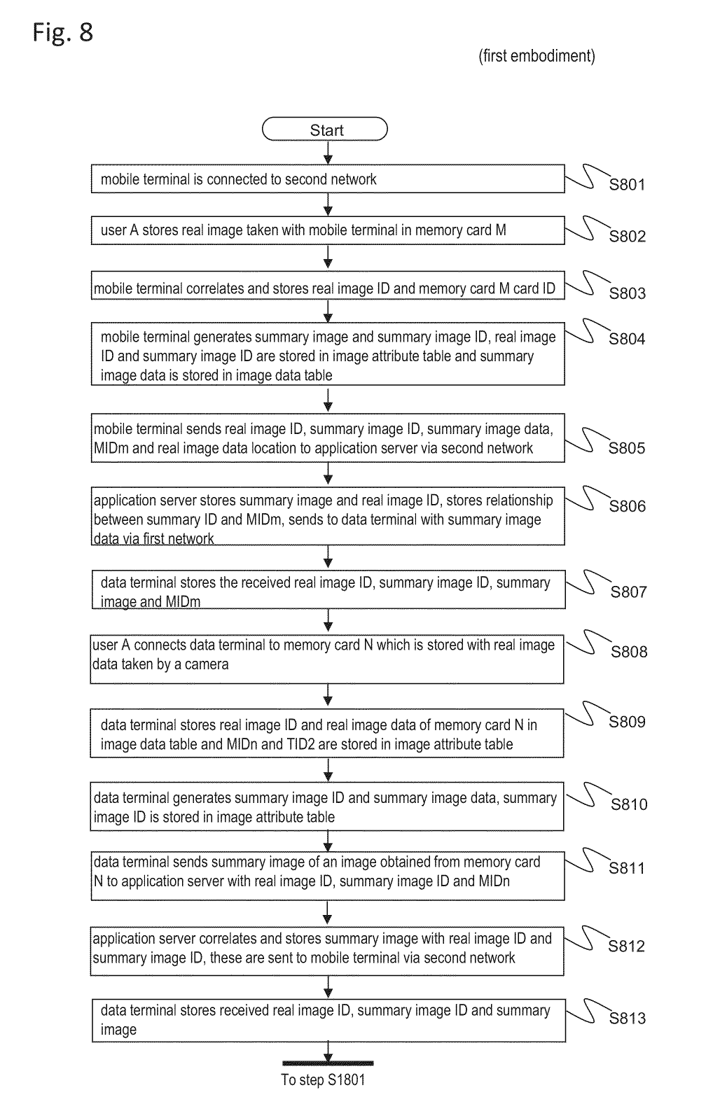

Using the flow diagram in FIG. 8, a method of using an image taken by the imaging terminal 100 in the data terminal 120 as well as a method of using an image stored in the data terminal 120 in the mobile terminal 100, in contrast, are explained as an example of one embodiment of the present invention. In the first embodiment, the imaging terminal 100 and data terminal 120 are linked by combining the second network 192 with a lower communication speed and has many available locations where it can be used and the first network 191 with a higher communication speed and few available locations where it can be used. In the explanation below, the second network 192 is explained as a 3G mobile phone line such as W-CDMA, CDMA2000 or TD-SCDMA as an example. In addition, the first network 191 is explained as high speed IP communication with a cable such as Internet line, Ethernet (registered trademark), IEEE802.11b, IEEE802.11g, or so-called Wi-Fi. However, in the present invention the second network 192 and first network 191 are not limited to these. The networks may be any type of network as long the communication speed of first network 191 is higher than that of the second network 192.

A user A who uses the mobile terminal 100 and the data terminal 120 connects the mobile terminal 100 to the second network 192 (step S801). This corresponds to connecting the mobile phone 100 to a 3G line for example. Next, the user A takes an image using the imaging means 104 of the mobile terminal. A real image data produce by the imaging means 104 is sent to the memory card M180 via the memory card input and output means 103 along with a real image ID for specifying the real image data. In the example in FIG. 7 (a), a card ID which specifies the memory card M is given as MIDm. When the input and output means 181 receives a real image ID and a real image data corresponding to the real image ID, the memory card M correlates these and stores them in the image storage means 182 (step S182).

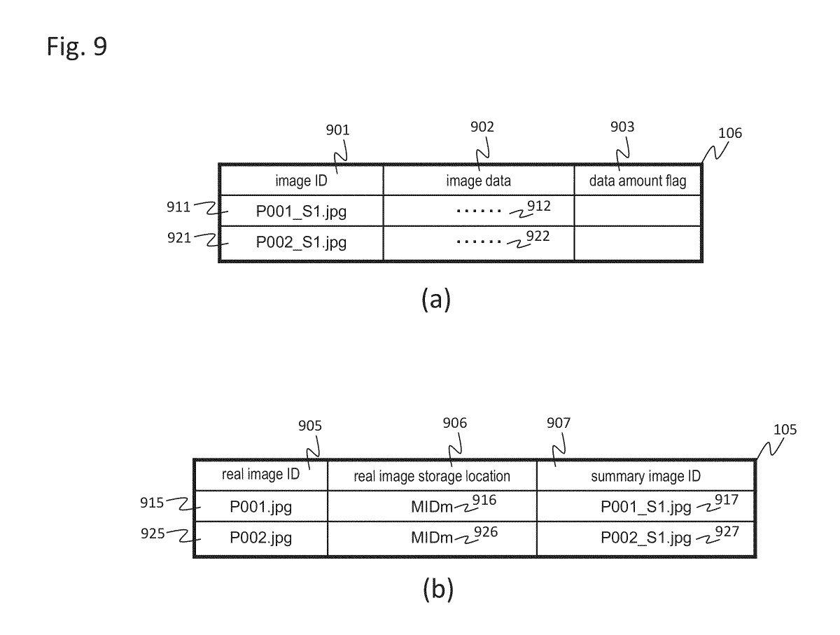

Next, the input and output means of the memory card 180 sends a card ID for specifying the memory card M and which is stored in the card ID storage means 182 to the mobile terminal. When the memory card input and output means 103 of the mobile terminal receives this, the card ID is correlated with the real image ID of the image taken in step S802 and stores MIDm in the image attribute table 105 (step S803). Furthermore, the image data amount change means 107 of the mobile terminal generates a summary image of the image taken in step S802 and a summary image ID which uniquely specifies the summary image. Next, the image attribute table 105 of the mobile terminal correlates this with the real image ID and stores the summary image ID generated at this time. In addition, at this time, the generated summary image data is correlated with the summary image ID and stored in the image data table 106 (step S804). An example of the image data table 106 after step S804 has been carried out is shown in FIG. 9 (a). The image data table 106 includes an image ID row 901, an image data row 902, and a data amount flag row 903. The data amount flag row 903 can be used in the second embodiment explained below. A real image ID or a summary image ID may be stored in the image ID row. In addition, a real image data or a summary image data may be stored in the image data row 902. In the example in FIG. 9 (a), summary image data 912 and 922 generated in step S804 are correlated with each summary image ID respectively and stored. Following this, a summary image data or a real image data are stored in a table is shown by [ ]. In addition, an example of the image attribute table 105 is shown in FIG. 9 (b). The image attribute table 105 includes a real image ID row 905, a real image storage location row 906, and a summary image ID row 907. The real image IDs 915 and 925 are real image IDs of images taken in step S802 described above. The real image storage locations 916 and 926 are memory card M IDs stored with real image data in step S803 and are for specifying a location stored with real image data representing each real image ID. Furthermore, the summary image IDs 917 and 927 represent summary images of real image data represented by the real image IDs 915 and 925.

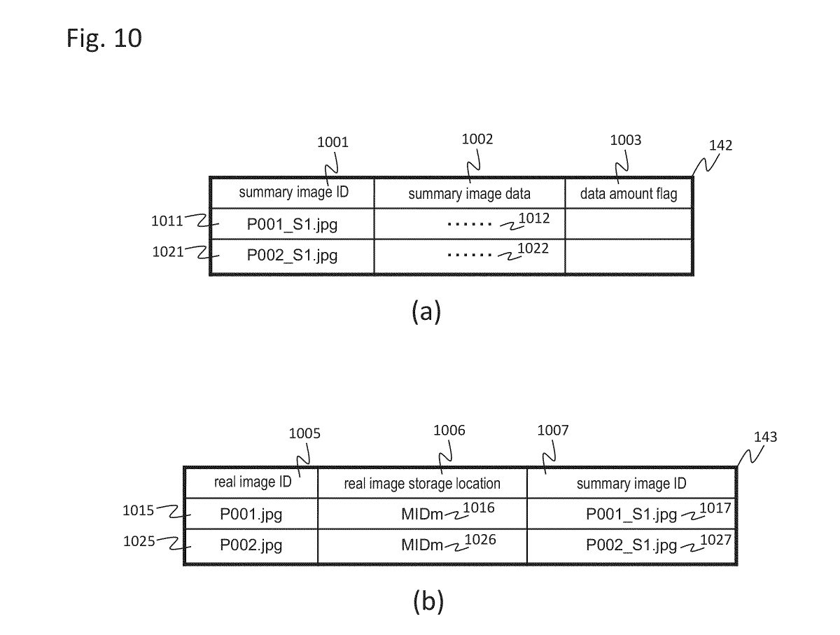

Next, the second network sending and receiving means 101 of the mobile terminal sends a summary image data, a summary image ID and a real image storage location correlated with a real image ID to the application server 104 via the second network 192 (step S805). When the application server 140 receives these, the real image ID and the summary image data are correlated and stored in the summary image data table 142, and the real image ID, the real image storage location, and the summary image ID are correlated and stored in the image attribute table 143. Furthermore, the sending and receiving means 141 sends a real image ID, a summary image ID, a summary image data, and a real image storage location, which are received from the mobile terminal 100 to the data terminal via the first network 191 (step S806). An example of the summary image data table 142 after step S806 has been carried out is shown in FIG. 10 (a). The summary image data table 142 includes a summary image ID row 1001, a summary image data row 1002, and a data amount flag row 1003. The data amount flag row 1003 is used in the second embodiment of the present invention explained below. In the first embodiment, it is possible to not store real image data in the summary image table 142. In FIG. 10 (a), summary image data 1012 and 1022 sent from the mobile terminal 100 in step S805 are correlated with summary image IDs 1011 and 1021 respectively and stored. In addition, an example of the image attribute table 143 after step S806 143 is carried out is shown in FIG. 10 (b). The image attribute table 143 includes a real image ID row 1005, a real image storage location row 1006, and a summary image ID row 1007. In FIG. 10 (b), real image IDs 1015 and 1025 sent from the data terminal in step S805 are correlated with the summary image ID 1017 and 1027 and also with the real image storage locations 1016 and 1026 respectively and stored.

Next, when the network sending and receiving means 121 of the data terminal 120 receives a real image ID, a summary image ID, a summary image data, and a real image storage location sent from the application server 140 in step S806, the real image ID, the summary image ID, and the real image storage location are correlated and stored in the image attribute table 123, and the summary image ID and the summary image data are correlated and stored in the image data table 124 (step S807). It is possible to provide the image attribute table 123 and the image data table 124 of the data terminal 120 with the same structure as the image attribute table 105 and the image data table 106 of the mobile terminal 100 respectively.

Next, user A connects the memory card N185 to the memory card input and output means 122 of the data terminal (step S808). At this time, a real image data taken by an imaging terminal such as a camera and stored in the memory card N is stored in the image storage means 187 of the memory card N. Next, the input and output means 186 of the memory card N sends a real image ID and the real image data stored in the image storage means 187 and a memory card ID stored in the card ID storage means 188 to the data terminal 120. In the example in FIG. 7 (b), the card ID of the memory card N is given as MIDn.

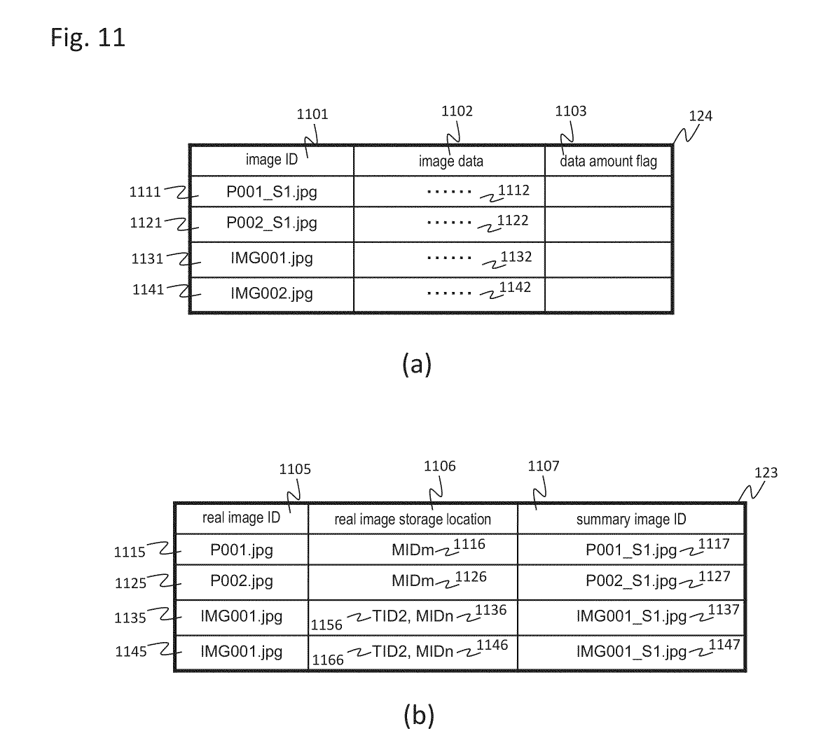

When the memory card input and output means 122 of the data terminal receives these, the image data table 124 correlates and stores the real image ID and the real image data. In addition, the received MIDn and the terminal ID of the data terminal 120 stored in the terminal ID storage means 128 are correlated with the real image ID and stored in the image attribute table 123 (step S809). An example of the image data table 124 after step S809 has been carried out is shown in FIG. 11 (a). In addition to the summary image data 1112 and 1122 received from the application server 140 and stored in step S809, an example of the state of the real image data 1132 and 1142 received from the memory card N and stored in step S809 is shown. In addition, step S809 shows an example of the state of the real image storage locations 1156 and 1166 correlated with the real image ID1135 in FIG. 11 (b) and the storage state of the real image storage locations 1166 and 1146 correlated with the real image ID1145. The card IDs 1116 and 1126 are received from the application server 140 and stored in FIG. 11 (b). These show that the real image data represented by the real image IDs 1115 and 1125 are stored in the memory card M180. In addition, the card IDs 1136 and 1146 are stored in step S809 after being obtained from the memory card N. In addition, the terminal IDs 1156 and 1166 are stored after being obtained from the terminal ID means 128 in step S809. These show that real image data represented by the real image IDs 1135 and 1145 are stored in both the memory card N and the data terminal 120. The summary image IDs 1137 and 1147 are data expressing a blank until the next step S810.

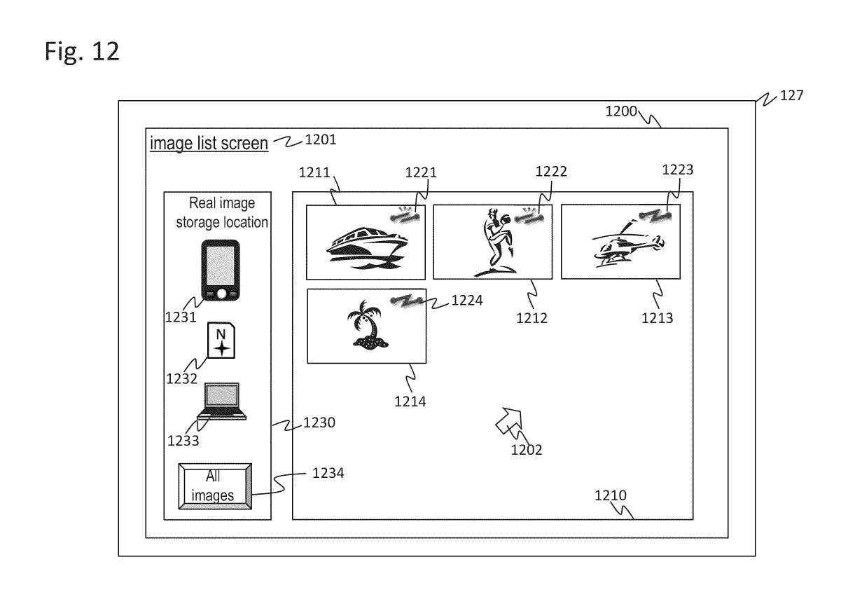

Next, the user A requests an image list screen by operating the input means 126 of the data terminal. Then, after generating an image list screen the display means displays the screen using the data of the image data table 124. An example of the image list screen in the data terminal 120 after step S809 has been carried out is shown in FIG. 12. The image list screen includes an image list window 1200. The image list screen 1200 includes a display part 1201 which represents an image list screen, an image display part 1210, and a real image storage location display part 1230. In the example in FIG. 12, four images 1211, 1212, 1213, and 1214 are displayed in the image display part 1210. These are compressed images of the image data 1112, 1122, 1132, and 1142 of the image data table 124 displayed in the display means 127. Therefore, 1211 and 1212 represent summary images and 1213 and 1214 represent real images. The displays 1221 and 1222 which are correlated with images 1211 and 1212 respectively are summary images and express the fact the data terminal 120 cannot obtain real image data. However, the displays 1223 and 1224 correlated with the images 1213 and 1214 respectively show that real image data are stored in the image data table 124 of the data terminal and that the data terminal 120 can obtain real image data. Referring to FIG. 11 (b), from the real image storage location data correlated with the real image IDs 1135 and 1145 which represent images 1213 and 1214, it can be seen that these real images are stored in the image data table 124 of the data terminal 120 and the memory card N185 connected to data terminal 120.

In the example in FIG. 12, an image which expresses a storage location of a real image data is displayed in the real image storage location part 1230. The image 1231 indicates the mobile terminal 100, the image 1232 indicates the memory card N, and the image 1233 indicates the data terminal 120. In the example in FIG. 12, the user A moves a cursor 1202 displayed in the display means 127 using the input means 126, selects the image 1231, only the images 1211 and 1212 are displayed in the display part 1210 and the images 1213 and 1214 disappear. That is, only images stored with real image data in the memory card M connected to the mobile terminal 100 is displayed in the image display part 1210. In addition, a user A moves the cursor 1202 displayed in the display means 127 using the input means 126, selects the image 1232, only the images 1213 and 124 are displayed in the image display part 1210 and the images 1211 and 1212 disappear. That is, only an image with a real image data stored in the memory card N185 is displayed in the image display part 1210. Similarly, when the user A selects image 1233, only the images 1213 and 1214 stored with real image data in the data terminal 120 are displayed in the image display part 1210. When the user A selects the image 1234, all images despite the real image storage locations are displayed, that is, images 1211, 1212, 1213, and 1214. In the example in FIG. 12, the real image storage location includes a filter function which selectively displays real image data stored in a mobile terminal, a memory card, or a data terminal.

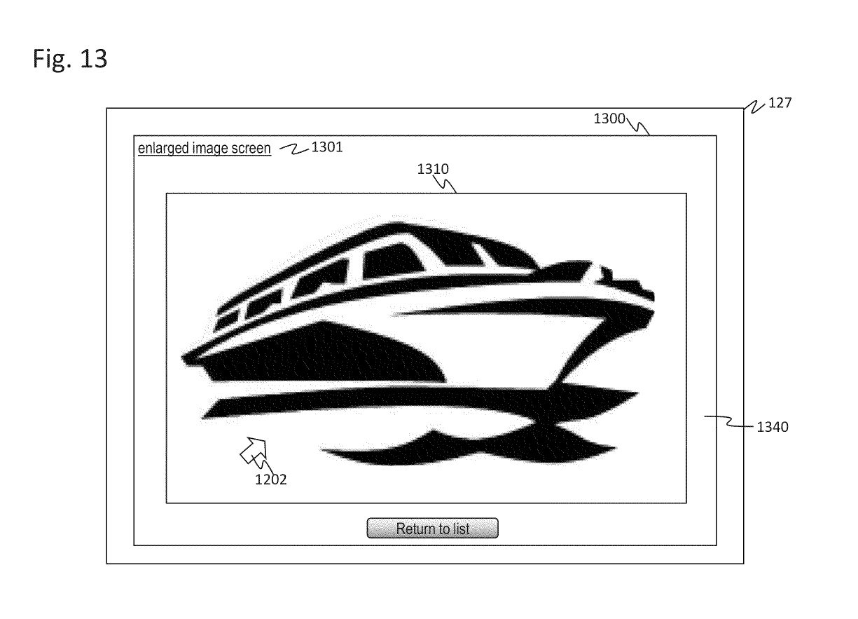

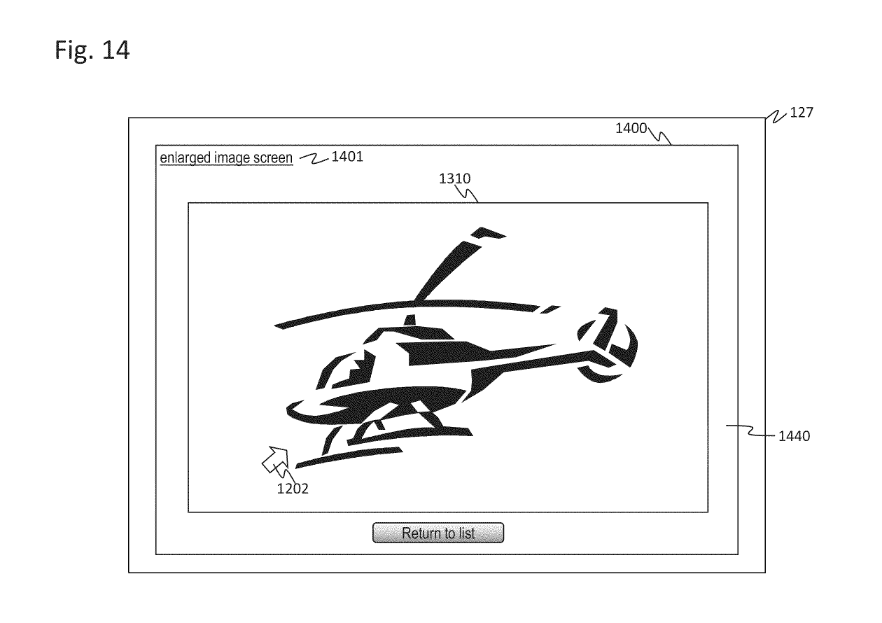

Next, the user A moves the cursor 1202 displayed in the display means 127 by operating the input means 126, selects image 1211 and the display means 127 displays an enlarged version of this image. The image 1211 in FIG. 12 displays the summary image data 1112 stored in the image data table 124. Since a summary image data has a smaller amount of data compared to a real image data, for example, an enlarged display becomes an image with a low resolution as in the enlarged image 1310 shown in FIG. 13. In the case where the image data 1112 is a video, a video with a low quality such as by dropping some frames is displayed. In addition, for example, the user A selects image 1213 in FIG. 12, an enlarged image is displayed in the display means 127, and becomes an image with a high resolution such as the enlarged image shown in FIG. 14.

In general, a user wishes to collectively manage image data taken with a mobile terminal and image data taken with a dedicated imaging terminal such as a camera and stored in a data terminal via a memory card. In the case where the second network 192 is a low speed line such as a mobile phone 3G line, it was necessary to send a real image taken using the mobile terminal 100 to the data terminal 120 via the 3G line in order to collectively manage images of a mobile terminal and images of a data terminal under the conventional method. However, in this type of method, since a large amount of time is required for transferring real image data using a low speed line, convenience for a user is lost. Furthermore, under the conventional method, there is the problem whereby the limited bandwidth of providers of mobile communication is consumed by the transfer of real image data.

Under the method of the present invention explained so far, only summary images of images taken using the mobile terminal 100 are sent to the data terminal 120 via the second network 192 immediately after images being taken. As a result, as is shown in FIG. 12 to FIG. 14, summary images of images taken using the mobile terminal 100 can be collectively managed and used along with image data taken by a dedicated imaging terminal and imported to the data terminal 120 via a memory card. However, since real image data with a large amount of data is not sent via the second network 192, compression of image data transfer time and conservation of bandwidth of the low speed second network can be realized compared with the conventional method. In addition, as is explained in the second embodiment of the present invention below, it is possible to change the amount of data of a summary image sent to the data terminal 120 by the mobile terminal 100 via the second network 192 and application server 140 in response to the speed of the second network 192. As a result, in the present invention, it is possible to realize optimization of the amount of data sent via the network 192 and the quality of summary images managed by the data terminal 192 in response the speed of the second network 192.

Next, the image data amount change means 125 generates a summary image data and a summary image ID for specifying the summary image data from the real image data received from the memory card N. Next, the image attribute table 123 of the data terminal correlated the summary image ID with the real image idea and stored the summary image ID generated at this time (step S810). FIG. 11 (b) is one example of the image attribute table 123 after step S810 has been carried out. The summary image IDs 1137 and 1147 generated by the image data amount change means in step S810 are each correlated with the real image IDs 1135 and 1145 and stored respectively.

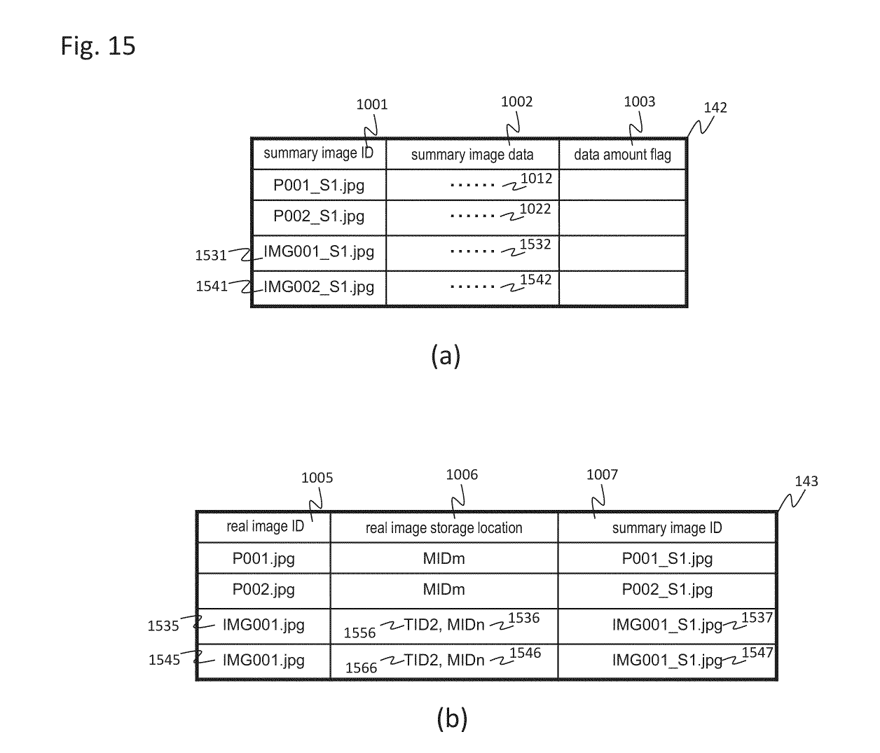

Next, the network sending and receiving means 121 of the data terminal sends the summary image ID and the summary image data generated in step S810 to the application server 140 via the first network together with card ID of the memory card N and the terminal ID of the data terminal (step S811). The sending and receiving means 141 of the application server receives these, correlates the received summary image ID and the summary image data and stores them in the summary image data table 142. In addition, the real image ID, the summary image ID, the card ID of the memory card N, and the terminal ID of the data terminal, which are received, are each correlated and stored in the image attribute table 143. An example of the summary image data table 142 and image attribute table 143 after this process is carried out is shown in FIGS. 15. 1532 and 1542 in FIG. 15 (a) are summary image data stored at this time. In addition, real image ID rows 1535 and 1545 in the image attribute table 143 are newly added here. In this state, the content of the image attribute table 143 of the application server and the image attribute table 123 of the data terminal 120 are the same.

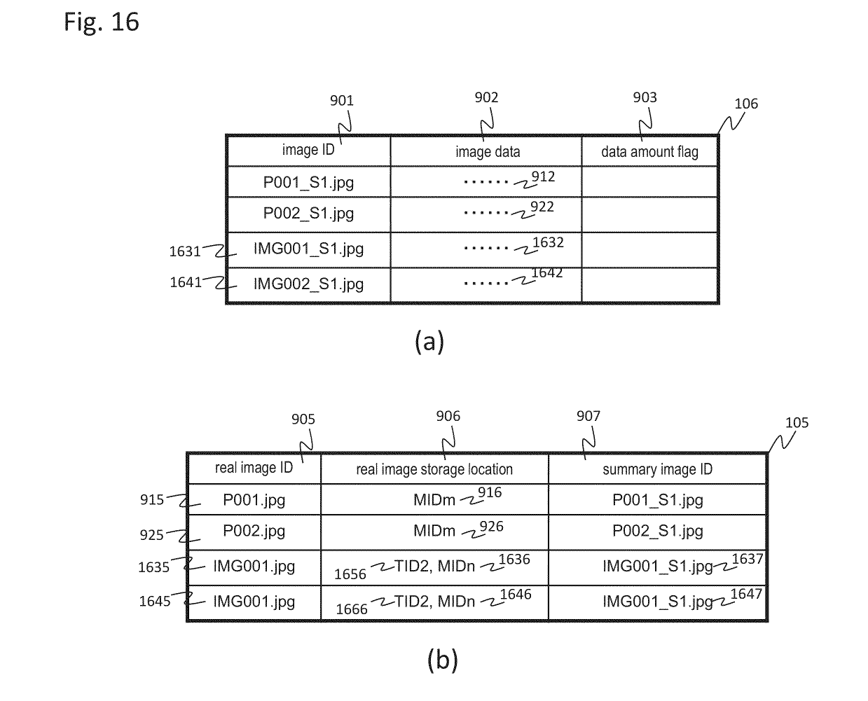

Next, the sending and receiving means of the application server sends the real image ID, the summary image ID, the summary image data and the real image storage location, which has been received from the data terminal 120, to the mobile terminal 100 via the second network 192 (step S812). When these are received by the second network sending and receiving means 101 of the mobile terminal, the summary image ID and the summary image data, which are received, are correlated and stored in the image attribute table 106. In addition, the real image ID, the summary image ID, the card ID of the memory card N and the terminal ID of the data terminal, which are received, are correlated and stored in the image attribute table 105 (step S813). An example of the image data table 106 and image attribute table 105 after step S813 has been carried out is shown in FIGS. 16. 1632 and 1642 in FIG. 16 are summary image data stored in step S813. In addition, the real image ID rows 1635 and 1645 in the image attribute table 105 are newly added rows in step S813. After this state is reached, the contents of the image attribute table 143 of the application server, the image attribute table 123 of the data terminal 120, and the image attribute table 1005 of the mobile terminal all become the same.

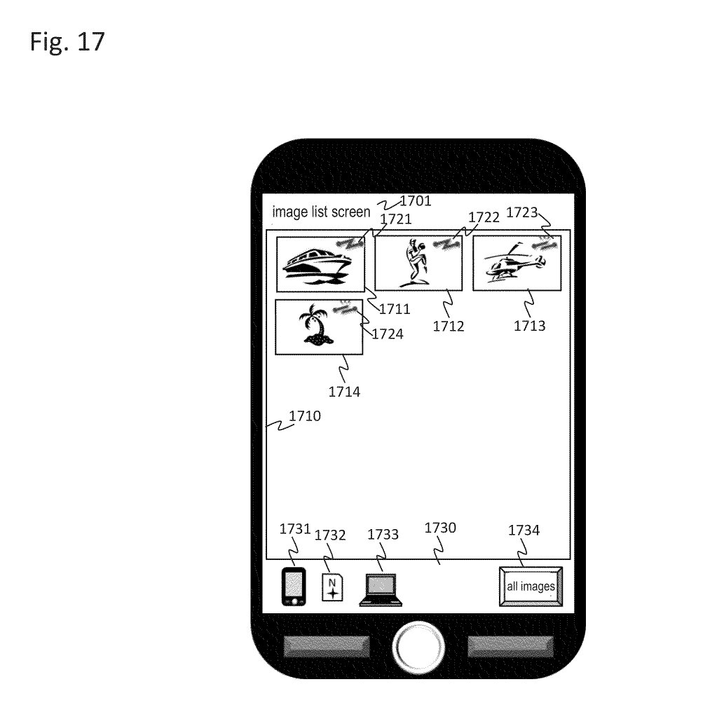

Next, by the operation by the user A of the input means 109 of the mobile terminal, the user A requests an image list screen. Then, the display means 110 displays an image list screen using the data of the image attribute table 106. An example of an image list screen in the mobile terminal 100 after step S813 has been carried out is shown in FIG. 17. The image list screen includes a display part 1701 which expresses the fact that this is an image list screen, an image display part 11710, and a real image storage location storage part 1730. In the example in FIG. 17, four compressed images 1711, 1712, 1713, and 1714 are displayed in the image display part 1710. These are the summary image data 912, 922, 1632, and 164 of the image data table 106 displayed in the display means 110. The displays 1721 and 1722 correlated with the images 1711 and 1712 respectively shows the state whereby it is possible to obtain real image data corresponding to the images 1711 and 1712 via the memory card input and output means 103 of the mobile terminal 100. On the other hand, the displays 1723 and 1724 show the state whereby real image data corresponding to the images 1713 and 1714 cannot be obtained by the mobile terminal 100. When the user A selects one image in the image lost display part 1710 using the input means 109 of the mobile terminal, the display means 110 displays an enlarged display of the selected image. Referring to FIG. 16, for example in the case where the user A selects the image 1711, the memory card input and output means 103 of the mobile terminal requests the real image data of the real image ID 915 along with the real image storage location 916 stored in the image attribute table 105 from the image storage means 183 of the memory card M and an image representing the image 1711 is displayed with an enlargement at a high resolution image in the display means 110. When the image 1713 is selected, an image representing the image 1713 is displayed with an enlargement at a low resolution in the display means 110.

Here, supposing that the memory card M180 is removed from the mobile terminal 100, because the image list screen in FIG. 17 displays the image data in the image data table 106 of the mobile terminal compressed, the images 1711, 1712, 1713, and 1714 do not change. However, the data terminal 100 can no longer obtain real image data of the images 1771 and 1712. This is expressed by changing to a display which represents the fact that real images cannot be obtained the same as the displays 1721 and 1722 in FIG. 17.

As already explained using FIG. 12 to FIG. 14, in the data terminal 120 the user A can collectively handle images stored with real image data taken by the mobile terminal 100 and stored in the memory card M and image data stored in the data terminal 120. On the other hand, FIG. 17 shows that in the mobile terminal 100 the user A can collectively handle image data stored with real image data taken by the imaging terminal A and stored in the memory card N185 and images stored with real image data taken with mobile terminal 100 and stored in the memory card M. In the present invention, regardless of whether it is possible to provide the user A with this convenience, because only a summary image data with a smaller amount of data than that of a real image data is transferred via the low speed second network 192 and the application server, it is possible realize a reduction in transfer time and conservation of bandwidth of the low speed second network.

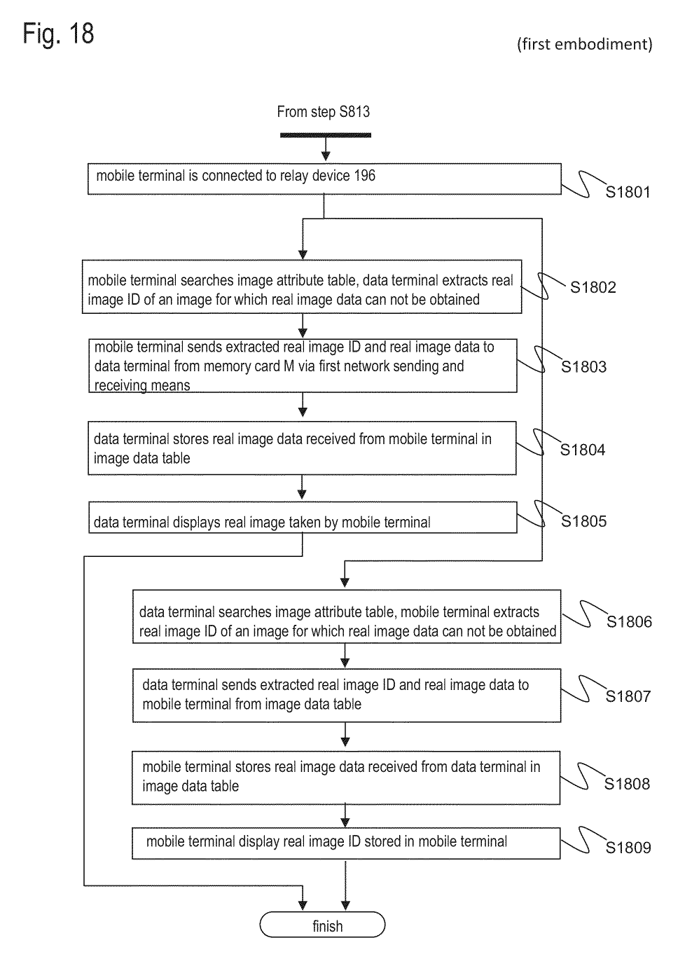

Next, the first embodiment is explained using the flow chart shown in FIG. 18. In the processes up to step S813, summary images are received between the mobile terminal 100 and the data terminal 120 via the second network 192. For example, this corresponds to a situation where the user A uses the mobile terminal at an outside location and collectively handles image taken with the mobile terminal and store in the data terminal. Next, the case where the user A moves to a location, such as at home, at work, or at a place where Wi-Fi is available, which the mobile terminal 100 can be connected to the high speed first network is considered. In the example in FIG. 1, connecting the mobile terminal 100 to the relay device 196 connected to the data terminal 120 is explained as (step S1801). This corresponds to the case where both a mobile terminal and a data terminal are connected to a home router. However, the mobile terminal 100 and the data terminal 120 in the present invention do not require connection to the same relay device and may be capable of sending and receiving image data via the first network.

The mobile terminal is connected to the relay device 196, for example, and when a communication via the first network sending and receiving means 102 becomes possible, the search means 111 of the mobile terminal searches the real image storage location column 906 of the image attribute table 105, TID2, which is the terminal ID of the data terminal 120, is not stored, and the real image ID of an image stored with MIDm, which is the card ID of the memory card M, is searched (step S1802). This is a state whereby real image data cannot be used in the data terminal 120 from the image data table 105 and means that the mobile terminal 100 searches for an image in a state whereby real image data can be used. Again referring to FIG. 16, as a result of this, the real image IDs 915 and 925 are obtained. Because each of the real image storage locations 916 and 926 correlated and stored with these real image IDs are the card ID of the memory card M, the search means 111 searches the image storage means 183 of the memory card M using the real images IDs 915 and 925 as a search result via the memory card input and output means 103. Next, the mobile terminal 100 obtains the real image data, which is to be searched, via the memory card input and output means 103, correlated with each real image ID respectively and sends to the data terminal 120 from the first network sending and receiving means 102 (step S1803).

In the first embodiment, as is shown in FIG. 1, the mobile terminal 100 is explained as being connected with the data terminal 120 via the relay device 196. However, in the present invention, sending a real image data to the data terminal 120 form the mobile terminal 100 may be performed via the first network 191, the high speed network 193, or the application server 140 and may also be performed via the relay device 196. For example, after the mobile terminal 100 performs a POST of a real image data to the application server 140 which is a HTTP protocol server, the data terminal 120 issues a GET request to the application server 140 and the real image data may be received via the relay device 196, the first network 191, the relay device 197, or the high speed network 193. In addition, for example, the data terminal 120 may become a HTTP protocol server and receives a POST request of an image data from the mobile terminal 100 and reversely, the mobile terminal 100 may become a HTTP protocol server and receive a GET request from the data terminal 120 and a real image data may be sent from the mobile terminal 100 to the data terminal 120. The protocol used for transfer of data may be any protocol.

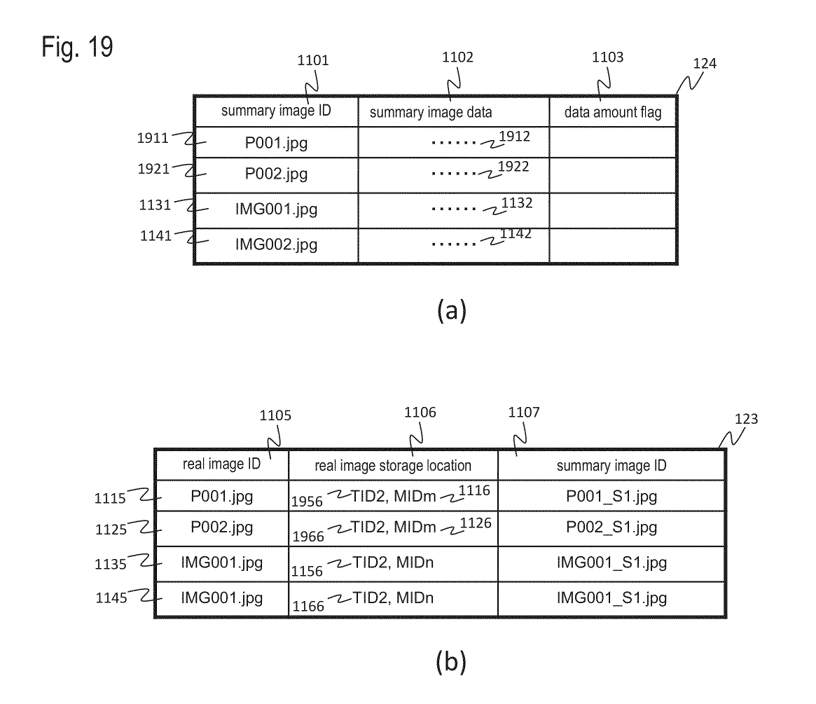

Next, when the network sending and receiving means 121 of the data terminal receives a real image ID and a real image data sent from the mobile terminal 100 in the step S1803, these are stored in the image data table 124 (step SS1804). An example of the image data table 124 and image attribute table 123 after step S1804 has been carried out is shown in FIG. 19. As is shown in FIG. 11 (a), the summary image data 1112 and 1122 is correlated with the summary image ID 1111 and 1121 and stored in the image data table 124 before step S1804 is carried out. As is shown in FIG. 19 (a), these are replaced with the real image data 1912 and 1922 correlated with the real images IDs 1911 and 1921 via step S1804. In addition, as is shown in FIG. 11 (b), the image attribute table 123 before step S1804 is carried out is in a state whereby the real image IDs 1115 and 1125 are each correlated with the card IDs of the memory card M 1116 and 1126 are each correlated. As is shown in FIG. 19 (b), the terminal IDs 1956 and 1966 correlated with these real image IDs are each newly correlated and stored via step S1804.

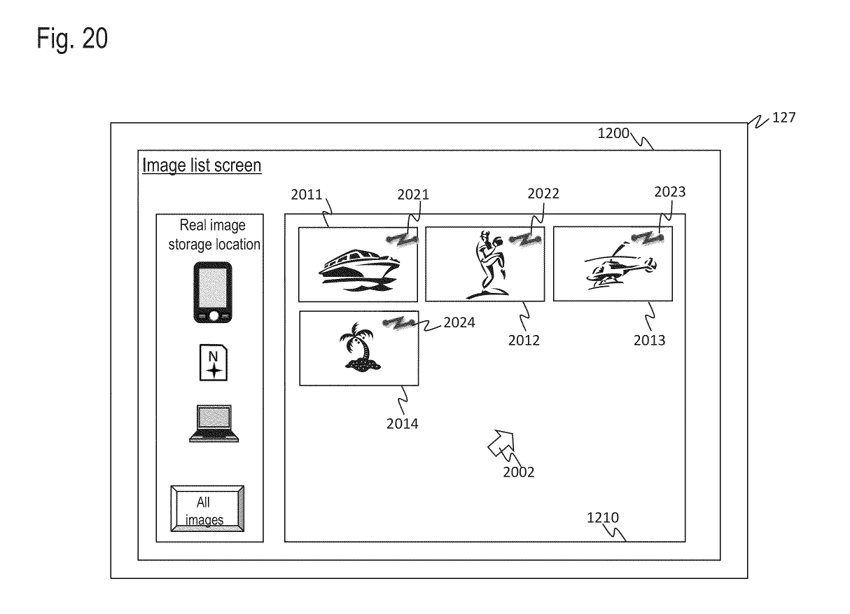

Next, the display means 127 displays an image list screen based on the image data in the refreshed image data table 124 (step S1805). An example of the refreshed image display screen is shown in FIG. 20. Before step S1804 is carried out, the display means 127 is in the state shown in FIG. 12. However, after step S1804 is carried out, the state changes to that shown in FIG. 20. Comparing FIG. 12 and FIG. 20, the displays 1221 and 1222 in the image list display screen each change to the displays 2021 and 2022 respectively. This shows that the data terminal 120 is in a state whereby the real image data represented by the image 2011 and image 2012 can be obtained. In this state, when the user A selects image 2011 by moving the cursor 2002 using the input means 126, the display means 127 displays the image 2011 enlarged. In this case, because it is possible for the data terminal 120 to use the real image data stored in step S1804, a high resolution image is displayed unlike that in FIG. 13.

In addition, when it is detected that the mobile terminal is connected to the relay device 196 (step S1801) and that the mobile terminal is connected to the first network sending and receiving means 102, this is notified to the data terminal 120 via the first network sending and receiving means 102 or the second network sending and receiving means 101. When the data terminal 120 receives this notification, the search means 129 of the data terminal searches the real image storage location column 1106 of the image attribute table 123, TID1 which is a terminal ID of the mobile terminal 100 or MIDm which is a card ID of the memory card M are not stored and a real image ID of an image stored with TID2 which is a terminal ID of the data terminal 120 is searched (step S1806). Again referring to FIG. 19, as a result of this, the real image IDs 1135 and 1145 are obtained. Since the real image storage locations 1156 and 1166 are correlated with the real image IDs and stored, the search means 129 searches the image data table 124 using the real image IDs 1131 and 1141 as a search key. Next, the network sending and receiving means 121 of the data terminal correlates the real image data obtained as a result of this search with the real image IDs which are then sent to the mobile terminal 100 via the network sending and receiving means 121 (step S1807).

In the first embodiment, as is shown in FIG. 1, the data terminal 120 is explained as being connected with the mobile terminal 100 via the relay device 196. However, in the present invention, sending real image data to the mobile terminal 100 from the data terminal 120 may be performed via the first network 191, the high speed network 193, or the application server 140 and may also be performed via the relay device 196. For example, after the data terminal 120 performs a POST of the real image data to the application server 140 which is a HTTP protocol server, the mobile terminal 100 issues a GET request to the application server 140 and the real image data may be received via the relay device 196, the first network 191, the relay device 197 and the high speed network 193. In addition, for example, the mobile terminal 100 may become a HTTP protocol server and receive a POST of image data from the data terminal 120 and reversely, the data terminal 120 may become a HTTP protocol server and receive a GET request from the mobile terminal 100 and real image data may be sent from the data terminal 120 to the mobile terminal 100. The protocol used for transfer of data may be any protocol.

Next, when the first sending and receiving means 102 of the mobile terminal receives the real image ID and the real image data sent from the data terminal 120 in step S1807, these are stored in the image data table 106 (step S1808). Before step S1808 is carried out, the image data table 106 in the state shown in FIG. 16 rewrites the summary image ID1631 with the corresponding real image ID “IMG001.jpg”, rewrites the summary image ID 1641 with the corresponding real image ID “IMG002.jpg” and the summary image data 1632 and 1642 are rewritten with corresponding real image data. In addition, in the real image storage location column 906 in the image attribute table, TID1 which is the terminal ID of the mobile terminal 100 correlated with each real image ID 1365 and 1645 is newly added. Because a change in the image data terminal 106 and the image attribute table 105 in step S1808 is the same as a change in the data terminal 120 from FIG. 11 to FIG. 19, drawings are omitted.

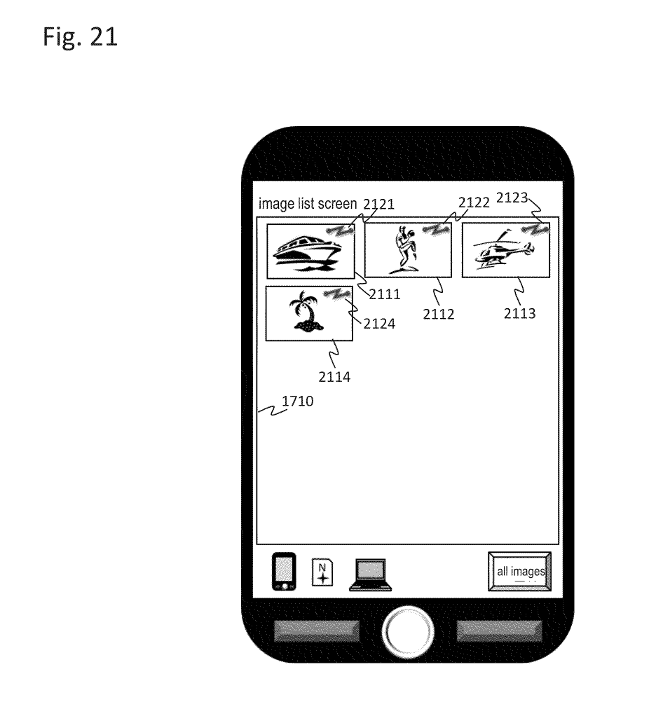

Next, the display means 110 displays an image list screen based on the image data in the refreshed image data table 106 (step S1809). An example of the refreshed image display screen is shown in FIG. 21. Before step S1808 is carried out, the display means 110 is in the state shown in FIG. 17, however, after step S1808 is carried out, the state changes to that shown in FIG. 21. Comparing FIG. 17 and FIG. 21, each of the displays 1723 and 1724 in the image list display screen changes to the displays 2123 and 2124 respectively. This shows that the mobile terminal 100 is in a state whereby real image data indicating the images 2113 and image 2114 can be obtained via the process in the S1808. In this state, when the user A selects image 2113 using the input means 109, the display means 127 displays the image 2113, which is enlarged. In this case, because it is possible for the mobile terminal 100 to use the real image data stored in step S1808, a high resolution image is displayed unlike that before step S1808 is carried out.

In the present invention, as explained above, after the mobile terminal 100 is connected to the first network or after direct communication with the data terminal 120 is possible (step S1801), real image data which can be used by the mobile terminal 100 is sent to the data terminal 120 and real image data which can be used by the data terminal 120 is sent to the mobile terminal 100 via the first network or by direct communication and stored respectively. In this way, it is possible to use real image data taken with the mobile terminal 100 in the data terminal and reversely it is possible to use real image data stored in the data terminal 120 in the mobile terminal.

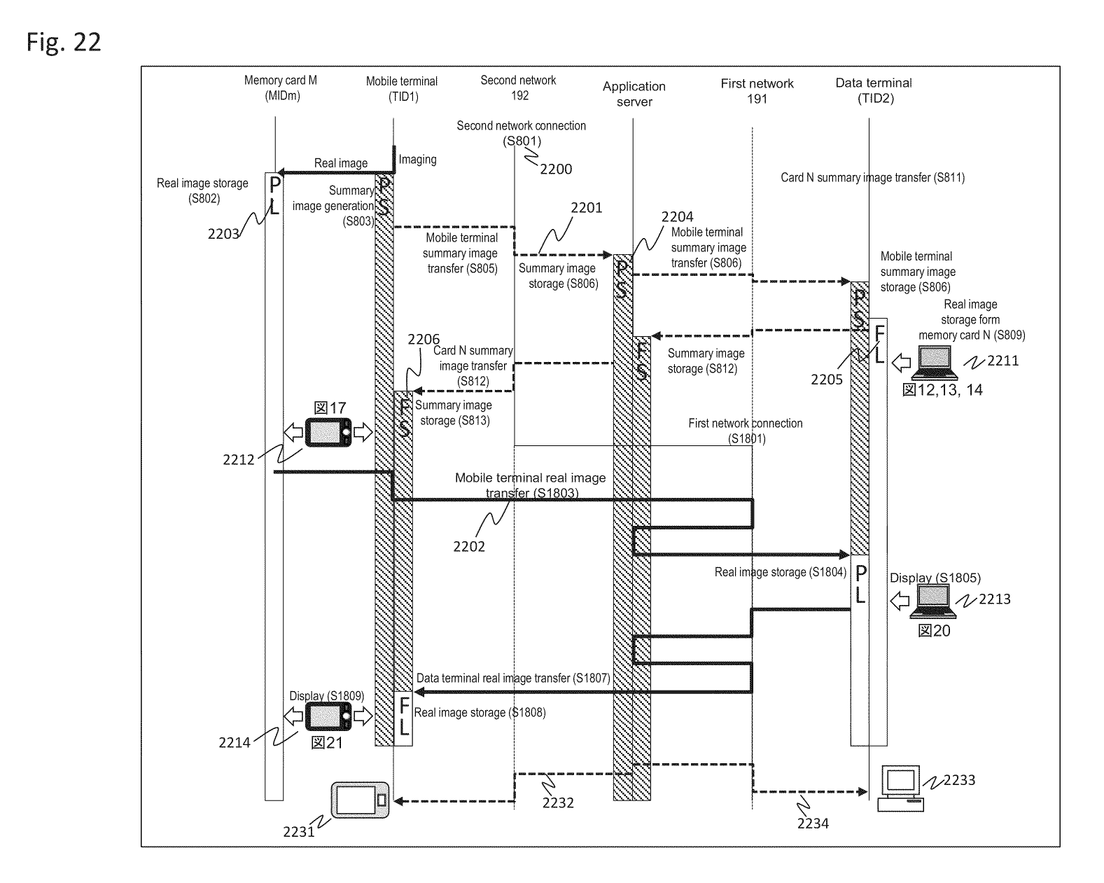

The contents explained referring to FIG. 8 and the flow chart in FIG. 18 is shown summarized in FIG. 22. FIG. 22 represents how real image data and summary data is received between the memory card M180, the mobile terminal 100, the second network 192, the application server 140, the first network 193, and the data terminal 120 using a sequence diagram. In FIG. 22, for example, as in the display 2200, a reference number which begins with S within the brackets indicate a step reference number in FIG. 8 or FIG. 18. In addition, a thick solid line arrow such as the arrow 2202 indicates a transfer of real image data and a broken line arrow such as the arrow 2201 indicates a transfer of summary image data. In addition, a shaded band labeled PL in the upper part indicates that real image data of an image taken with the mobile terminal 100 is stored. For example, the shaded band 2203 indicates that a real image data taken using the mobile terminal 100 is stored in the memory card M. In addition, a shaded band labeled with FL in the lower part indicates that a real image data taken by an imaging terminal and obtained from the memory card N185 is stored. For example, the white band 2205 shows the state whereby real image data obtained from the memory card N in step S809 is stored in the data terminal 120 in step S809. Similarly, a band with a diagonal line labeled PS in the upper part indicates that summary image data of an image taken by the mobile terminal 100 is stored. For example, a diagonal line band 2204 indicates that a summary image data taken by the mobile terminal 100 is stored in the application server 140. In addition, a diagonal line band labeled FS in the upper part indicates that a summary image data of an image taken by an imaging terminal and obtained from the memory card N185 is stored. For example, the diagonal line band 2206 indicates the state whereby summary image data obtained from the memory card N is stored in the mobile terminal 100 in step S813. In addition, for example, as in the subsequent steps to step S809, S812, S813, a display with two overlapping bands indicates a state whereby both are stored in a terminal or server.

The display means of the data terminal shown in FIG. 12, FIG. 13, and FIG. 14 is in the state shown in 2211 in FIG. 22. The display means 110 of the mobile terminal shown in FIG. 17 is in the state shown in 2212 in FIG. 22. The display means 127 of the data terminal shown in FIG. 20 is in the state shown in 2213 in FIG. 22. In addition, the display means 110 of the mobile terminal shown in FIG. 21 is in the state shown in 2214 in FIG. 22.

As can be seen from FIG. 22, the data terminal 100, the application server 140, and the data terminal 120 receive summary image data shown by the dotted line while the mobile terminal is connect to the second network (step S801 to S813). As a result, each terminal and server can collectively handle summary image data or real image data of all images held by the user A in both a mobile terminal and a data terminal. Next, when the mobile terminal is connected to the first network 191 (step S1801), a real image data shown by the thick solid line is received. As a result, the user A can collectively user all the real image data in both the mobile terminal 100 and the data terminal 120.

In the first embodiment, an image data is received by one mobile terminal 100 and one data terminal 120 via the first network 191 and the second network 192. In the method of the present invention, a reception of image data can also be performed between a plurality of mobile terminals, a plurality of data terminals and between a plurality of mobile terminals and data terminals.

In addition, in the first embodiment and example of the present invention is explained assuming that a real image data taken by the storage means mobile terminal 100 is not stored but only a summary image data is stored. The capacity of a storage means of a mobile terminal is often small and in such a case the method of the first embodiment is effective. However, in the present invention, a real image data may be stored not in the memory card M180 but in the storage means of the mobile terminal 100.

In addition, in the present invention, when the mobile terminal 100 is connected to the first network, a real image data stored in the mobile terminal 100 is sent to the data terminal 120 and a real image data of the data terminal 120 is sent to the mobile terminal 100. While in the explanation in the first embodiment, sending and receiving these real image data is performed with the mobile terminal 100 being a trigger, for example, the application server 140 or the data terminal 120 may be a trigger for sending and receiving real image data after the application server 140 or the data terminal 120 periodically enquires to the mobile terminal 100 whether the mobile terminal is connected to the first network 191 and searching for a connection to the first network 191.

In addition, in the first embodiment, after connecting the first network 191, sending and receiving of a real image data is performed both from the mobile terminal 100 to the data terminal 120 and from the data terminal 120 to the mobile terminal 100. However, sending and receiving of a real image data after connection to the first network 191 in the present invention may also be performed either from the mobile terminal 100 to the data terminal 120 or from the data terminal 120 to the mobile terminal 100.

In addition, in the first embodiment, the user A selects an image from a list display screen in the mobile terminal 100 and the data terminal 120 and an enlarged display of the image is displayed in a display means. However, use of a real image data or a summary image data stored in the image data table of the mobile terminal 100 and the data terminal 120 is not limited to an enlarged display. For example, a real image data or a summary image data stored in the image data table of the mobile terminal 100 and the data terminal 120 may be printed by each device or submitted to a Web service via a network.

In addition, in the first embodiment, a summary image data of an image taken by the mobile terminal 100 and a summary image data of an image stored in the data terminal 120 are stored by the application server 140. However, in the present invention, the mobile terminal 100 and data terminal 120 may receive a summary image data and a real image data using a method such as in the first embodiment and a summary image data does not need to be stored by the application server. In this case, the fifth effect described below cannot be obtained.

Next, the operational effects of the present invention related to the first embodiment are explained using FIG. 22. The present invention includes the following seven effects. The first to fifth effects are effective to the user A, who is a user of a mobile terminal and data terminal. In addition, the sixth effect is effective to a communication provider who manages the second network. Furthermore, the seventh effect is effective to a network service provider who operates an application server.

The first effect is that it is possible to manage and use images taken by a mobile terminal in a data terminal together with images stored in the data terminal. In a conventional method, in order for a user to use image data taken by a mobile terminal in a data terminal, complex operations are necessary such as connecting the mobile terminal via the first network of the data terminal and then copying real image data. Referring to FIG. 22, according to the present invention, at the time of step S809, summary image data of images taken using a mobile terminal and real image data stored by a data terminal can be collectively used as is shown in FIG. 12, FIG. 13 and FIG. 14. A user does not need to worry about locations of real images and can use all image data with a data terminal in a timely fashion.

The second effect is that images taken by a camera, stored in a memory card or copied from a memory card to a data terminal and managed by the data terminal may be managed and used by a mobile terminal together with images taken by the mobile terminal. In a conventional method, in order for a user to use image data taken by a camera and managed by a data terminal in a mobile terminal, complex operations are necessary such as connecting the mobile terminal with data terminal via the first network and then copying real image data. Referring to FIG. 22, according to the present invention, at the time of step S813, summary image data of all images stored in a data terminal and real image data stored in a mobile terminal or a memory card M can be collectively used as is shown in FIG. 17. A user does not need to worry about locations of real images and can use all image data with a data terminal in a timely fashion.

The third effect of the present invention is that if a mobile terminal cannot be connected to a first network such as Ethernet (registered trademark) or Wi-Fi but can connect to a second network such as a 3G line, it is possible to immediately obtain the first and second effects. Generally, a low speed network such as a mobile phone 3G line can be used in many locations by moving users, however, use of a high speed network such as Ethernet (registered trademark) or Wi-Fi is limited to locations such as homes, in places of work, at hotels, and places where public Wi-Fi services are provided. According to the conventional method, in order for image data taken by a mobile terminal and image data stored in a data terminal to be collectively managed, it is necessary to either directly connect a mobile terminal to a data terminal or copy real images in a state where communication is possible via a high speed network limited to certain locations. According to the present invention, simply by connecting a mobile terminal to a low speed network such as a 3G line which is used over a wide area range, it is possible to automatically and collectively manage image data stored in a mobile terminal and data terminal in both terminals.

The fourth effect is that even if it is possible to manage and use image data of a mobile terminal and image data of a data terminal, the transfer time of the second network is short in a state where a high speed line such as Ethernet (registered trademark) or Wi-Fi cannot be used. Conventionally, a method for managing images of a mobile terminal and image data of a data terminal entails synchronizing images between a mobile terminal, an application server, and a data terminal via a second network. However, in this method, a large amount of exchange of real image data with a large amount of data via the second network is necessary. In particular, when a large amount of real image data having a data amount of a few megabytes per image is sent via a mobile phone 3G line for example, a significant amount of transfer time is required, which is not practical. In the present invention, since data transfer using a low speed line is limited summary images, the time required for transferring image data using a second network is significantly reduced.

The fifth effect is that it is possible for a user to browse all images managed using a mobile terminal and data terminal from a mobile terminal and a data terminal which include a Web browser. In the present invention, when summary image data is exchanged between a mobile terminal and a data terminal via a second network, the summary image data is stored by the application server 140 in the summary image table. Again referring to FIG. 22, subsequent to step S812, summary data of all images taken by a mobile terminal and all images stored in a data terminal are stored in the application server. Therefore, the user A can browse all summary images via the browser of each terminal even using a mobile terminal which is not a mobile terminal such as the mobile terminal 2231 of the present invention or a data terminal which is not a data terminal such as the data terminal 2233 of the present invention. In order to achieve this, the application server 145 generates HTML code for displaying summary image data of the user A from summary images in the summary image data table 142 and this is sent to the data terminal 2233 via a high speed line 2234 or sent to the mobile terminal via the second network 2232. For example, the data terminal 100 is assumed to be a mobile phone of the user A, the data terminal 120 is assumed to be a home computer of the user A, the data terminal 2233 is assumed to be a work place computer, and the mobile terminal 2231 is assumed to be a mobile phone belonging to a family. In this case, the user A can browse all summary images using a work place data terminal which is not a data terminal of the present invention and can submit images to another Web service. In addition, a family can browse all summary images of the user A using the family mobile terminal which is not a mobile terminal of the present invention. In actuality, even if images are displayed using a small display means on a mobile phone or summary images with a low resolution are used in the case of submitting another Web service, user convenience is seldom lost.

The sixth effect is that it is possible to reduce the costs for an operator of a second network while simultaneously providing a user with the first to fifth effects since the amount of data of images transferred using the second network is reduced compared to the conventional method. With the spread of smartphones in recent years, and the increase use of still images and video services using smartphones, the amount of transferred data using a low speed line such as 3G has increased dramatically. As a result, the necessity for new equipment investment due to a shortage in mobile phone communication capacity or deterioration in profitability of a mobile phone communication operator adopting flat-rate services have become significant problems. In order to tackle with this problem, mobile communication operators have resorted to measures such as forbidding transfer of real images via a second network such as 3G or charging users according to the amount of data transferred. However, in either case, user convenience is lost. According to the present invention, as can be seen from FIG. 22, by transferring summary images via a second network, user convenience is not lost and it is possible to dramatically reduce the cost of data transfer via a second network.

The seventh effect is that it is possible to reduce the costs to an operator of an application server compared to a conventional method in which real image data are stored in a server. Conventionally, a method for browsing images via a Web browser by storing the images of a data terminal or of a mobile terminal in a server and synchronizing real image data between a plurality of data terminals has been disclosed and similar services have been provided. However, when all real images data is stored in a server, the costs to an application server operator increases significantly, which is a problem. As a result, in most services, users are required to pay a charge for storing real image data which exceeds a predetermined data amount in an application server. However, according to the present invention, since only summary image data is stored in an application server it is possible to reduce the amount of data stored in the application server.

### Second Embodiment

In the first embodiment, a structure is described whereby summary image data in the case where the mobile terminal 100 is connected to the low speed second network 192 and real image data in the case where the mobile terminal 100 is connected to the high speed first network is received between the mobile terminal 100 and the application server 140. In the second embodiment explained next as another example of an embodiment of the present invention, an image data amount change means 107 of a mobile terminal and an image data amount change means 125 of a data terminal controls the data amount of summary image data and controls the amount of data of summary image data received between the mobile terminal 100 and the data terminal 120 according to the communication speed of a network. The second embodiment produces effects in the case for example where the communication speed of the second network 192 changes over time. In addition, the second embodiment is also effective when it is possible to connect the mobile terminal 100 to a plurality of networks having different speeds and switching between these networks. Furthermore, the second embodiment is effective in the case where a service provides of the second network 192 wishes to control the total amount of data of image data via the second network 192 in order to control congestion for example.

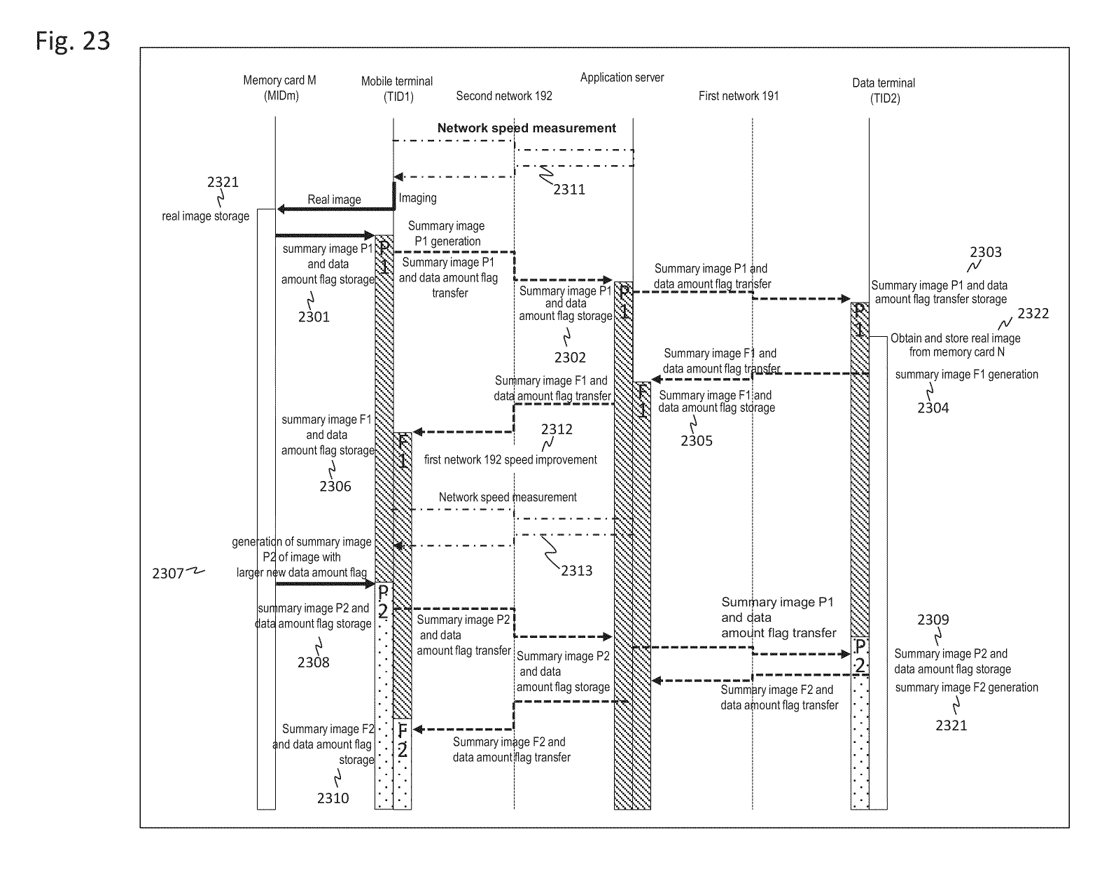

In the second embodiment, in addition to the processes in the first embodiment, a data amount flag of summary image data stored in each table is stored in the a data amount flag columns 903, 1103, and 1003 which exist in the image data table 106, the image data table 124, and the summary image table 142 respectively. Other than this, the processes are the same as in the first embodiment explained using FIG. 8 and thus a detailed explanation is omitted and the second embodiment is explained in abbreviated using the sequence diagram in FIG. 23.

In the example of the second embodiment, the data transfer speed of the second network 192 may change. In addition, a communication speed prediction means 113 of a mobile terminal periodically performs a communication request to the application server 140 via the second network sending and receiving means 101 and second network 192. For example, while there is a method whereby the second network sending and receiving means 101 issues a GET command for arbitrary data to the application server, the second network sending and receiving means 101 obtains a delay and throughput until data is received from the application server 140, and the communication speed predication means 113 determines the communication speed of the second network 192 from this data, in the present invention, any method may be used as long as it is possible for the mobile terminal to predict the communication speed of the second network 192. In addition, in the present invention, communication speed data predicted and generated by the communication speed prediction means 113 may include a delay, a return communication time with the application server, and an error rate in addition to network speed.

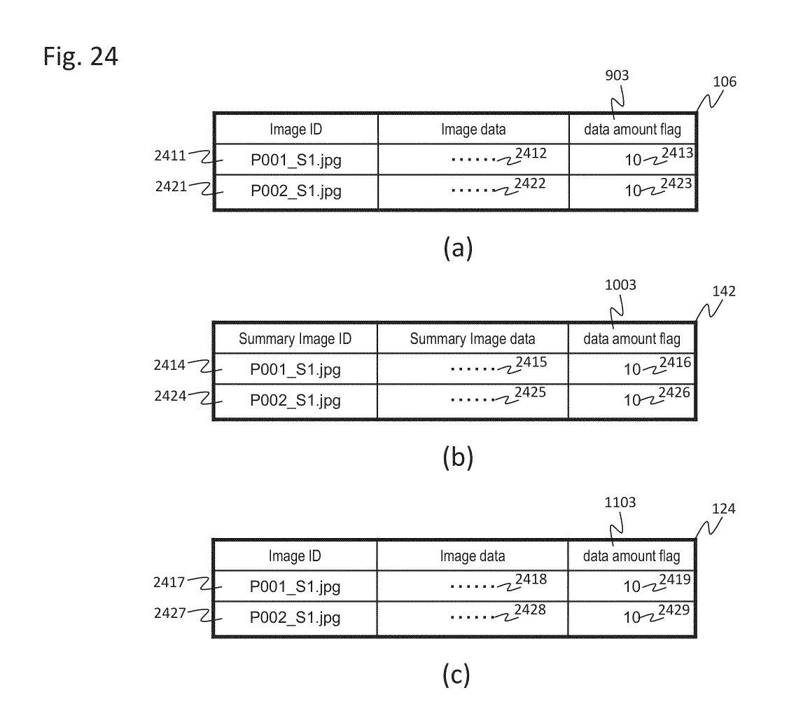

Again referring to FIG. 23, the first he communication speed prediction means 113 generates communication speed data by performing a speed measurement 2311 of the second network 192 through the second network sending and receiving means 101 and stores the data. Next, similar to the first embodiment, real image data taken by the imaging means 104 of the mobile terminal 100 is stored in the memory card M180 (2321), the image data amount change means 107 of the mobile terminal generates summary image data and a summary image ID, the summary image data is stored in the image data table 106 and an MIDm as a real image ID, a summary image ID, and a real image storage location (corresponding to step S804 in the first embodiment) are stored. At this time, in the second embodiment, the amount of data of the summary image data produced by the image data amount change means 107 is determined according to the communication speed data. Furthermore, the image data amount change means 107 generates a data amount flag which represents the amount of data of the summary image data from the communication speed data stored by the communication speed prediction means 113, and stores and correlated this with the summary image ID in the image data table 106. For example, a data amount flag may be a communication speed data or a result of a calculation on the communication speed data. For example, the data amount flag may be a transfer data amount per unit of time. An example of the image data table 106 after process 2301 has been carried out is shown in FIG. 24 (a). Similar to the first embodiment, summary image data 2412 and 2422 are stored and correlated with summary image IDs 2411 and 2421. Furthermore, in the second embodiment, the data amount flags 2413 and 2423 generated by the image data amount change means 107 are stored. In the example of FIG. 24, the data amount flag generated by the image data amount change means 107 is 10.

Next, the same processes as step S805, S806, and S807 in the first embodiment are carried out. However, in the second embodiment, in addition to these processes, the data amount flags of summary image data represented by 2411 and 2412 and generated by the image data amount change means 107 of a mobile terminal are stored in the summary image data table 142 of the application server and image data table 124. Each of these processes is the processes 2302 an 2303 in FIG. 23 respectively. An example of the summary image data table of the application server after process 2302 has been carried out is shown in FIG. 24 (b). In addition, an example of the image data table 124 of the mobile terminal after process 2303 is carried out is shown in FIG. 24 (c). For example, in the data terminal 120, similar to the first embodiment, summary image data 2418 and 2428 are correlated with summary image IDs 2417 and 2427 and stored. Furthermore, in the second embodiment, the data amount flags 2419 and 2429 generated by the image data amount change means 107 of a mobile terminal are stored.

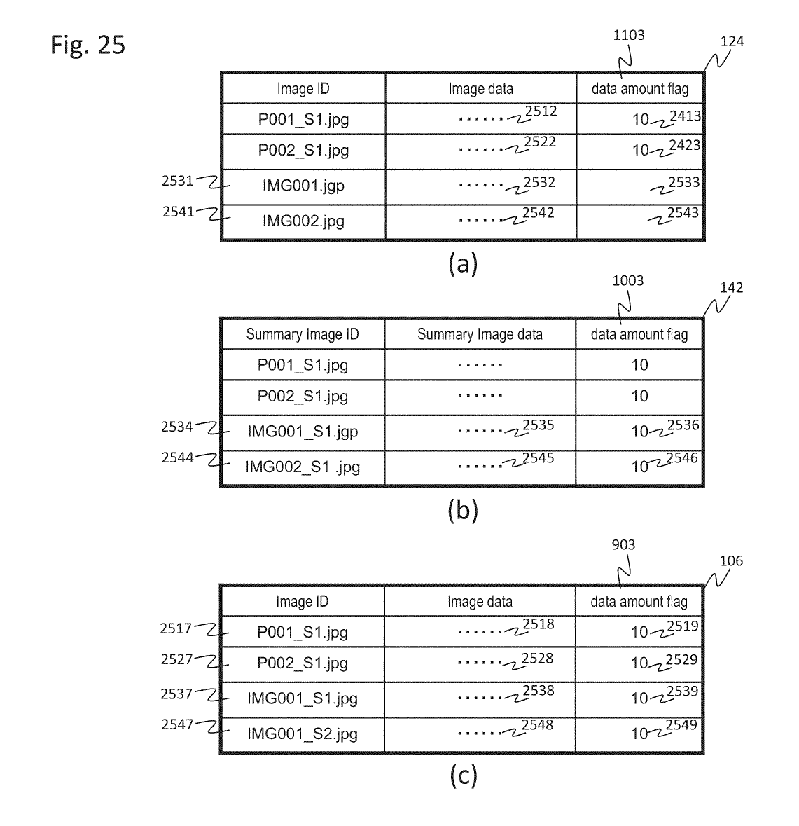

Next, similar to the first embodiment, real image data obtained by the data terminal 120 from the memory card N is stored in (2322) in the image data table 124 of the data terminal. In addition, TID2 and MIDn are correlated with a real image ID and stored in the image attribute table 123 as a real image storage location (corresponding to step S809 in the first embodiment). An example of the image data table 124 after process 2322 has been carried out is shown in FIG. 25 (a). In this example, since the image data 2532 and 2542 are real image data, the data amount flags 2533 and 2543 show data that is a blank or real image data. Next, the image data amount change means 125 generates a summary image ID (corresponding to step S810 in the first embodiment). At this time, in the second embodiment, a data amount of summary image data generated by the image data change amount mean 125 is determined based on the data amount flag 2423 sent from the mobile terminal 100. Next, the network sending and receiving means 121 sends a summary image ID, summary image data, and a data amount flag to the mobile terminal 100 via the application server 140, and the server 140 and the mobile terminal 100 store the summary image data (corresponding to step S810 to S813 in the first embodiment). In the second embodiment, in addition to these processes in the first embodiment, a data amount flag generated by the image data amount change means 125 of the data terminal is stored in the summary image data table 142 of the application server and the image data table 106 of the mobile terminal. These processes are the processes 2305 and 2306 in FIG. 23. An example of the summary image data table 142 of the application server after process 2305 has been carried out is shown in FIG. 25 (b). In addition, an example of the image data table 106 of the mobile terminal after process 2306 has been carried out is shown in FIG. 25 (c). Similar to the first embodiment, for example, summary image data 2538 and 2548 are correlated and stored with the summary image IDs 2537 and 2547. Furthermore, in the second embodiment, the data amount flags 2539 and 2549 generated by the image data amount change means 125 of the data terminal are stored.

Reference to FIG. 23 is made again. Assume that the communication speed of the first network 192 changes (2312). Next, the communication speed prediction means 113 of the mobile terminal carries out a network speed measurement 2313 of the second network 192 via the second network sending and receiving means 2313. Next, the data amount of summary image data generated by the image data amount change means 107 is determined based on the result of the network speed measurement 2313 and a corresponding data amount flag is calculated. In the second embodiment, the explanation continues with the new data amount flag calculated at this time being 20 with regard to all four summary image data stored in FIG. 24 (c). Next, the search means 111 compares the new data amount flag calculated at this time with the data amount flag stored in the column 903 in FIG. 25 (c). The data amount flag 20 newly calculated at this time is assumed to represent a higher transfer speed than the data amount flags 2519 and 2529 correlated and stored with the summary images 2517 and 2527. In this case, the memory card M is specified as a real image storage location from the real image storage locations 916 and 926 of the image attribute table 105 in the state shown in FIG. 16 (b). Next, after real image data corresponding to this is received from the memory card M, summary image data P2 corresponding to the new data amount flag 20 is generated (FIGS. 23 and 2307). In the case where the newly calculated data amount flag is equal to a data amount flag stored in the data amount flag column 903 of the image data table 106 or represents a lower transfer speed than this, it is not necessary to carry out subsequent processes.

Next, the image data 2518 and 2528 in the image data table 106 is rewritten with the newly generated summary image data and the data amount flags 2519 and 2529 are changed to the new data amount flag 20 (2308 in FIG. 23). Next, the second network sending and receiving means 101 sends new summary image data and a new data amount flag to the data terminal 120 via the application server 140. In addition, with respect to the summary image IDs 2537 and 2547, since it can be seen that real image data from the image attribute table 105 in the state shown in FIG. 16 (b) is stored in the data terminal 120 from the terminal IDs 1656 and 1666, a request to obtain summary image data corresponding to the data amount flag 20 is sent to the data terminal 120 via the application server.

the data terminal 120, which receives these, replaces the image data 2512 and 2522 in the image data table 124 with the new image data corresponding to the data amount flag 20 and the data amount flags 2413 and 2423 are replaces with the new data amount flag 20 (2309 in FIG. 23). In addition, the image data amount change means 125 of the data terminal generates (2321 in FIG. 23) new summary image data F2 from the real image data 2531 and 2541 in accordance with a request for summary image data corresponding to the data amount flag 20 received from the mobile terminal 100, and these are sent to the mobile terminal via the application server. When the second network sending and receiving means 101 of the mobile terminal receives the new summary image data F2, the image data 2358 and 2548 in the image data table 106 is replaced with new summary image data received from the data terminal 120 and the data amount flags 2539 and 2549 are rewritten with the new data amount flag 20 (2310 in FIG. 23).

As can be seen from FIG. 23, in the second embodiment, the mobile terminal 100 measures the speed of the second network 192 and at the point where a higher transfer speed than that of when the previous summary image data is exchanged with the data terminal 120 can be attained, it is possible to exchange a larger data amount which means images with a higher resolution.

Next, the effects of the present invention related to the second embodiment are explained while referring to FIG. 23. One characteristic of the second embodiment is that it is possible to vary the amount of data of summary image data generated and stored in the mobile terminal 100 and data terminal 120 and a data amount flag which expresses the amount of data of summary image data is correlated and stored with the summary image data. In addition to the seven effects described above in the first embodiment, three effects produced by the characteristics of the second embodiment are explained below. The eighth effect and sixth effect of the present invention are effective for users. The ninth effect of the present invention is effective for service providers of the second network.

The eighth effect of the present invention is that the first, second, fourth and fifth effects can be obtained even in the case where the network communication speed changes over time. For example, when the second network speed drops, a summary image data with a small amount of data is received between the mobile terminal 100 and the data terminal 120 and thus user A can obtain the convenience of rapid syncronisity of the summary image data between the mobile terminal 100 and data terminal 120 provided by the present invention. On the other hand, it is possible to reduce transfer time by not sending and receiving summary image data with a large amount of data in the state where the speed of the first network drops. When time elapses and the transfer speed of the first network improves, image data with a large amount of data can be received between the mobile terminal and the data terminal according to the transfer speed which is measured. In this way, it is possible for the user A to use better quality image data between the mobile terminal and the data terminal.

The ninth effect is that the first, second and fifth effects can be obtained even in the case where it is possible to connect the mobile terminal to a plurality of networks having different speeds and switch between these networks. Up until now, as is shown in FIG. 1, a mobile terminal that can communicate with a high speed first network such as Wi-Fi and a low speed second network such as 3G has generally been the case. However, in recent years, the demand for improvements in mobile communication speed is large with developments in various wireless communication technologies such as LTE (Long Term Evolution), DC-HSDPA (Dual Cell High Speed Downlink Packet Access and Wi-Max2 to be used instead of or in combination with 3G and there are many mobile terminals compatible with a plurality of wireless communication standards. Generally, there is a contradictory relationship whereby locations where high speed wireless networks can be used are few and locations where low speed wireless networks can be used are many. According to the present invention, it is possible to automatically receive summary images with a data amount corresponding to the communication speed of a network in a mobile terminal which can switch between a plurality of communication standards.

The tenth effect is that it is possible for an operator which manages a second network 192 such as a mobile communication operator to control the amount of data of images received via the second network 192. In recent years, bandwidth management of a 3G line with the spread of smartphones has led to a deterioration in profitability for mobile phone service providers. In the second embodiment, the communication speed prediction means 113 measures the communication data of the second network and stores the result as communication speed data. The data amount change means 107 and 125 determines a data amount of summary image data generated based on the communication speed data. However, in the present invention, communication speed data stored by the communication speed prediction means 113 is sent to a mobile terminal by a server of an operator of the second network via the second network or the first network and this may be stored by the communication speed prediction means 113. In this case, the data amount change means 107 and 125 determines the data amount of the summary image data which is generated according on the communication speed data sent from the server of the operator of the second network. In this way, the operator of the second network can control the data mount of image data handled by a second network at an arbitrary timing.

### Third Embodiment

In the first and second embodiments, the application server 140 stores summary image data in the summary image data table 142. This reduces the costs related to a storage means by not storing real image data and it is possible to browse all summary image data via a Web browser in the mobile terminal 100 or the data terminal 120 (2232 and 2234 in FIG. 22). In actuality, a method of providing a service which stores real image data in a server and sends the data to a mobile terminal or data terminal via a network is common. The present invention can also be used for a server to store real image data. In the third embodiment, as is shown in FIG. 2, real image data is stored in the image server 160, this is sent to a mobile terminal via the first network or the second network and is browsed using a Web browser in the mobile terminal. At this time, as is shown in FIG. 2, a data amount of image data which is sent and received via a network by the image server 160 is adjusted according to the speed of the network to which the mobile terminal is connected. While in the second embodiment described above, the speed of a network is measured by a mobile terminal and the image data amount change means of the mobile terminal adjusts the data amount of the summary image data, in the third embodiment, a server performs the measurement and the image data change means 163 of an image server changes the data amount of the summary image data.

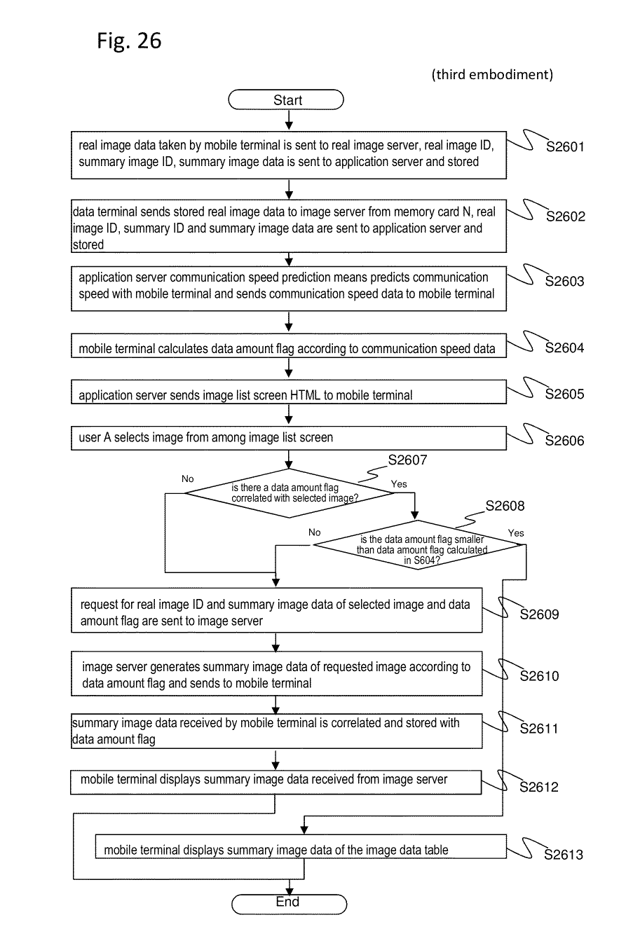

Next, the processes of the third embodiment are explained using the flow diagram shown in FIG. 26. In the third embodiment, a real image data is sent to the image server 160 from the mobile terminal 100 and the data terminal 120 and stored in the real image data table 162. First, real image data taken and generated by the mobile terminal 100 is sent to the image server 160 and stored in the real image data table 162. In addition, this summary image data is sent to the application server 140 and stored in the summary image data table 142 (step S2601). Furthermore, the data terminal 120 sends the real image data obtained and stored by the memory card N and stores the data in the real image data table 162. In addition, this summary image data is sent to the application server 140 and stored in the summary image data table 142 (step S2602). In steps S2601 and S2602, sending of real image data to the image server 160 and sending of the summary image data to the application server 140 may be carried out via the first network and the second network. In addition, summary image data sent to the application server may be any type of summary information data as long as an HTML of a list display screen is generated. In addition, a summary image data generated from a real image data stored in the image server 160 may be sent to the application server 140 via the network 293 and stored. In addition, in this example, while a summary image data is sent to the application server from the mobile terminal 100 and the data terminal 120, in the present invention a summary image data is not sent but only a real image ID is sent and this may be stored in advance in the image attribute table of the application server. In this case, by burying a real image ID into an HTML code generated later by the application server 140, the mobile terminal 100 which receives the HTML code requests summary image data from the image server 160.

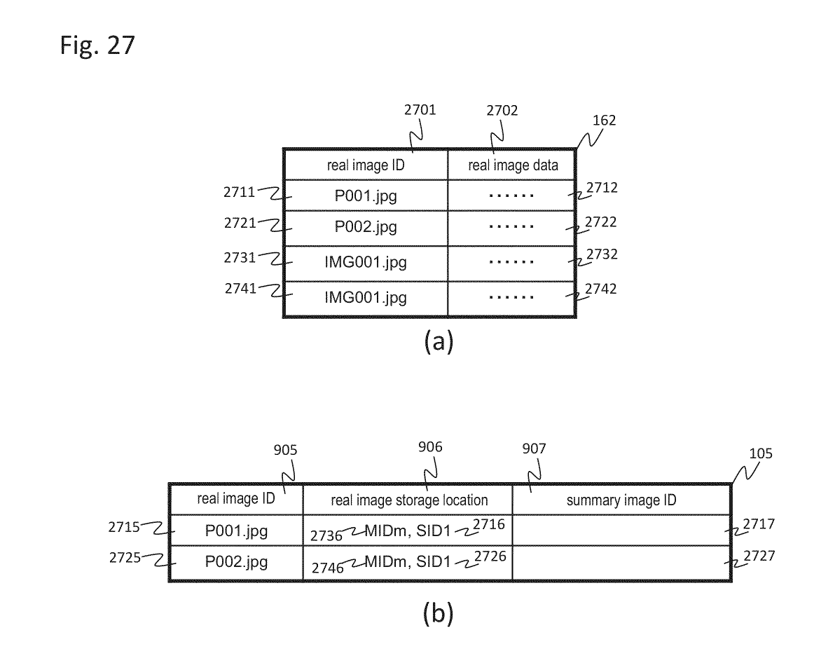

An example of the real image table 162 after step S2602 has been carried out is shown n FIG. 27 (a). The real image data table 162 includes a real image ID column 2701 and a real image data column 2702. The real image data 2712 and 2722 are received from the mobile terminal 100, and the real image data 2732 and 2722 are received from the data terminal 120. In addition, the image attribute table 105 at the time after step S2602 has been carried out is shown in FIG. 27 (b). Real image storage locations are stores in the image attribute table and are correlated with the real image ID 2715 and 2725. The card ID 2736 and the image server ID2716 are correlated with the real image ID 2715 and stored in the image attribute table 105. Here, the real image storage locations 2716 and 2726 are IDs which specify the image server 160. Therefore, for example, the row 2715 in FIG. 27 (b) illustrates that the real image data shown by this real image ID is stored in the memory card M180 and the image server 160. At this time, summary images are not generated, therefore, the summary image ID 2717 and 2727 are data which represent blanks. In addition, at this time, the mobile terminal 100 does not store image data and therefore the image data table 106 does not have a row and is in a blank state.

Next, as is shown in FIG. 2, the mobile terminal 100 is connected to the low speed second network via the relay device 296. Next, the communication speed prediction means 146 of the application server measures the communication speed between the server 140 and mobile terminal 100 via the second network and generates communication speed data. The communication speed prediction means 146 may be any method which can predict communication speed. For example, there is a method for the sending and receiving means 141 of the application server to send arbitrary data to the mobile terminal 100 via the network 293, the relay device 297, the second network 292, and the relay device 296, and measure the time for that response to return from the mobile terminal 100. In addition, for example, the communication speed data obtained via data transfer between the application server 140, the relay device 296, and relay device 295 in advance may be correlated with an ID for uniquely specifying the relay devices 296 and 295 and stored in advance in the in the communication speed storage means 147. Next, the sending and receiving means 141 of the application server sends the generated communication speed data to the mobile terminal 100 via the second network 292 and the relay device 296 (step S2603). When the second network sending and receiving means 101 of the mobile terminal received this communication speed data, the data is stored in the communication speed data storage means 114. Next, the image data amount change means 107 calculates a data amount flag of summary image data based on this communication speed data (step S2604). The data amount flag calculated here as 10 is explained below.

Next, the HTML generation means 145 of the application server generates an HTML code for displaying an image list of the user A based on the summary data stored in step S2601 and S2602. Next, the sending and receiving means 141 sends the HTML code to the mobile terminal 100 via the second network (step S2605). When the second network sending and receiving means 101 of the mobile terminal receives the HTML code, the HTML analysis means 112 analyzes the code and the display means 110 displays an image list display. In the case where the application 160 does not store summary image data in steps S2601 and 2602, a real image ID maybe embedded in the HTML code in advance, and summary image data required for generating an image list display may be obtained from the image server 160 when the mobile terminal 100 generated an image list display screen in step S2606.

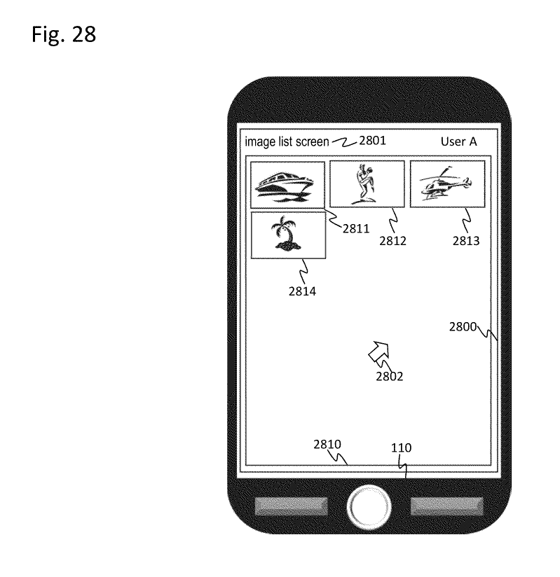

An example of an image list display displayed in the display means 110 is shown in FIG. 28. The display means 110 includes a Web browser window 2800 which analyzes the HTML code received from the application server 140 and displays an image list screen based on the result. The Web browser window 2801 includes a display 2801 which represents the fact that this is an image list screen and an image display part 2810. In the example in FIG. 28, images 2811, 2812, 2813, and 2814 are displayed in the image display part 2810. These images are stored in the summary image data table 142 of the application server in steps S26001 and S2602, and are generated from the real image data ID's 2712, 2722, 2732, and 2742 in FIG. 27. Although this image data list screen may include a real image storage location 1230 as is shown in FIG. 12 for example based on the data in the image attribute table 143, in the explanation here, it is omitted from FIG. 28. In the case where the application server 140 does not store summary image data, with regard to the images 2811-2814, real image IDs are embedded as hyperlinks in the HTML code, which is sent from the application server 140 to the image server 160. The image server 160 sends the summary image data generated by the image data amount change means 163 from real image data of a real image ID received from the mobile terminal 100 to the mobile terminal 100. The image list screen images 2811-2814 in FIG. 28 may also display this summary image display.

Next, the user A moves the cursor 2802 displayed on the display means 110 by operating the input means 109 of the mobile terminal and selects 2812 (step S2606). In the explanation of the third embodiment, in steps S2601 and 2602 described above, real image data and summary image data are only sent to the application server 140 and image server 140 respectively and image data is not stored in the image data table 106 of the mobile terminal. Therefore, there is no data amount flag correlated with a selected image and stored in the image data table 106. As a result, the process goes to the branch of “NO” in step S2607 shown in the flow diagram in FIG. 26.

Next, the second network sending and receiving means 101 of the mobile terminal sends a request for image data to the image server 160. At this time, a real image ID which shows that image 2813 is selected and 10 which is a data amount flag calculated in step S604 are sent to the image server and correlated with the request (step S2609). When the sending and receiving means 161 of the image server receives these, the search means 164 searches the real image data table 162 using the real image ID sent from the mobile terminal 100 in step S2609 as a search key, and obtains a real image data 2732. Next, summary image data determined by the data amount flag (value 10) sent from the mobile terminal 100 in step S2906 from the real image data 2732 by the image data change means 163 and a summary image ID which expresses it are generated. Next, the sending and receiving means 161 of the image server sends the summary image data and data amount flag to the mobile terminal 100 via the second network (step S2610).

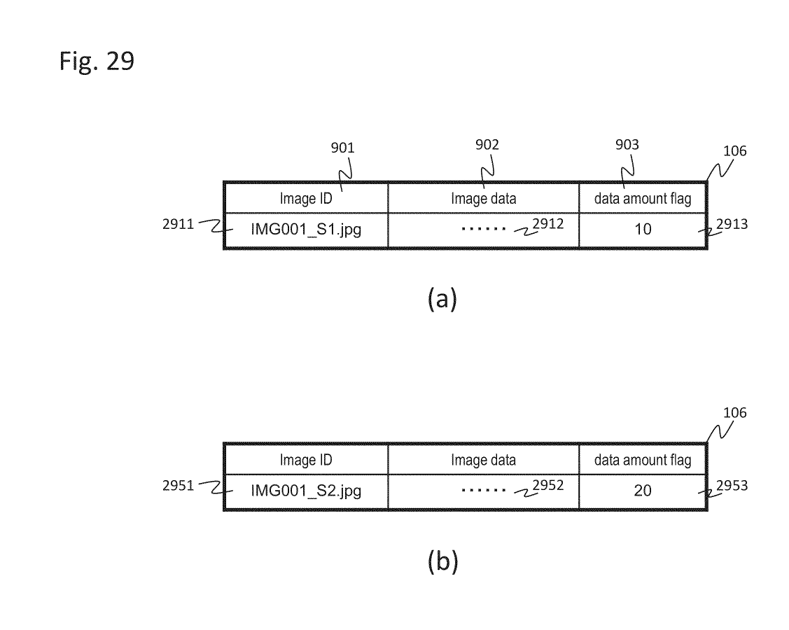

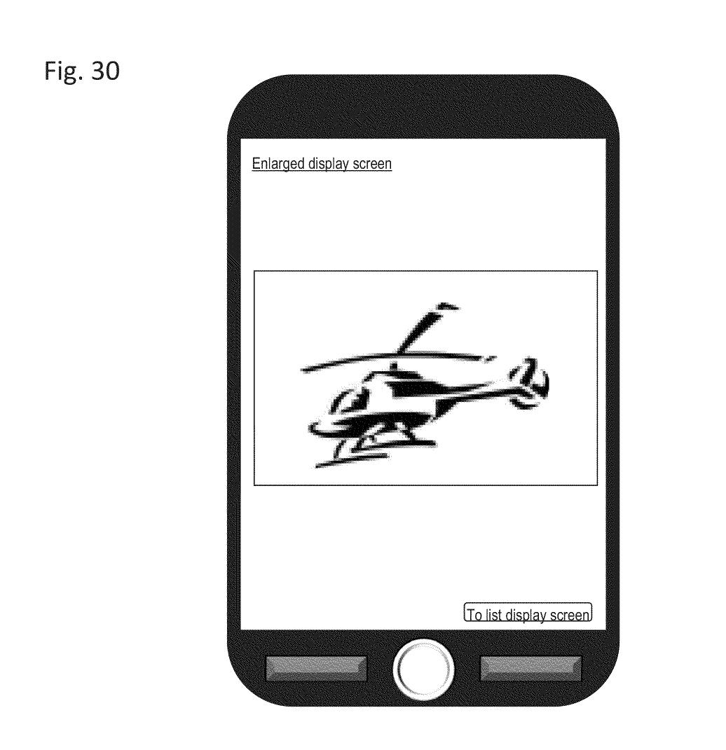

When the second network sending and receiving means 101 of the mobile terminal receives these, the summary image ID, the summary image data and the data amount flag are correlated and stored by the image data table 106 (step S2611). The image data table 106 after step S2611 is carried out is shown in FIG. 29 (a). Furthermore, the display means 110 displays the image selected in step S2606 with enlargement (step S2612). An example of the enlarged screen display after step S2612 is carried out is shown in FIG. 30.

Next, the user A removes the mobile terminal 100 from the relay device 296, which is shown in FIG. 2, and connects to the first network 291 by connecting it to the relay device 295. Following this, the user A browses image data stored in the image server 160 again using the mobile terminal 100. The processes following this are explained again using the flow diagram in FIG. 26. After the mobile terminal 100 is connected to the relay device 295, the communication speed prediction means 146 of the application server measures the communication speed between the server 140 and mobile terminal 100 via the first network and generates new communication speed data. Next, the sending and receiving means 141 of the application server sends the generated communication speed data to the mobile terminal via the first network 291 and the relay device 295 (step S2603). When the first network sending and receiving means 102 of the mobile terminal receives the new communication speed data, this data is stored in the communication speed data storage means 114. Next, the image data amount change means 107 calculates a new data amount flag of summary image data based on this new communication speed data (step S2604). In the explanation below, it is assumed that the new calculated data amount is 20. Before the data amount flag is calculated as 20, because a data amount flag calculated from the communication speed data received by the mobile terminal 100 via the second network from the application server 140 was 10, the new flag is larger than this. This reflects the fact that the communication speed of the first network 291 is higher than that of the second network 292.

Next, the HTML generation means 145 of the application server generates an HTNL code for display an image list display of the user A based on the summary image data stored in step S2601 and S2602 described above. Next, the sending and receiving means 141 sends the HTML code to the mobile terminal 100 via the first network (step S2506). When the first network sending and receiving means 102 of the mobile terminal receives this HTML code, the HTML analysis means 112 analyzes the code and the display means 110 display an image list display. In the case where the application server 160 does not store summary image data in steps S2601 and S2602, a real image ID is embedded in the HTML code, and when the mobile terminal 100 generates an image list display screen in step S2606, the summary image data required for generating an image list display may be obtained from the image server 160. In this example, the image list screen displayed in the display means 110 is the same as that shown in FIG. 28.

Next, the user A moves the cursor 2802 displayed in the display mean 110 by operating the input means 109 of the mobile terminal and selects 2813 the same as before (step S2606). However, unlike before, the summary image data 2912 of an image selected in step S2606 as is shown in FIG. 29 (a) is correlated with the data amount flag 2913 and stored. Therefore, the process goes to the branch of “YES” in step S2607 in FIG. 26. Furthermore, the data amount comparison means 115 compares the data amount flag 2913 stored in advance in the image data table and the newly generated data flag. In this example, as is shown in FIG. 29, although the value of the data amount flag stored in advance is 10 and the value of the data amount flag newly generated is 20, the value of the newly created data amount flag is larger. This corresponds to an improvement in speed of a communication network between the application server and the mobile terminal than when obtaining previous image data from the image server 160. Therefore, in this case the process goes to the branch of “NO” in step S2608 and the summary data with a large amount of data than previous is obtained from the image server 160. For example, in the case where the value of a newly generated data amount flag is 5, and is smaller than the value of a previously stored data amount flag, the network at the present time is judged to have a lower network communication speed than when the summary image data is obtained from the previous image server 160. In this case, the summary image data 2912 stored by the mobile terminal is displayed in the display means according to the image scale down selection in step S606 (step S2613). In the explanation below, it is assumed that the value of the presently generated data amount flag is 20 and the process goes to the branch of “NO” in step S2608.

Next, the first sending and receiving means 102 of the mobile terminal sends a request for image data to the image server 160. At this time, a real image ID which shows that image 2813 is selected and 20 which is the value of the newly calculated data amount flag in step S2604 are correlated with this request and sent to the image server 160 (step S2609). When the sending and receiving means 161 of the image server receives this, the search means 164 searches the real image data table 162 with a real image ID sent from the mobile terminal 100 as a search key in step S2609, and a real image data 2732 is obtained. Next, the image data change means 163 generates a new summary image data from real image data 2732 according to the data amount flag (value 20) sent from the mobile terminal 100 and a summary image ID which represents it in step S2906. Therefore, the summary image data presently generated includes a data amount larger than the summary image data sent previously to the mobile terminal 100 via the second network 292. Next, the sending and receiving means 161 of the image server sends a summary image ID generated here, the new summary image data and 20 which is the value of the data amount flag which represents this to the mobile terminal 100 via the first network (step S2610).

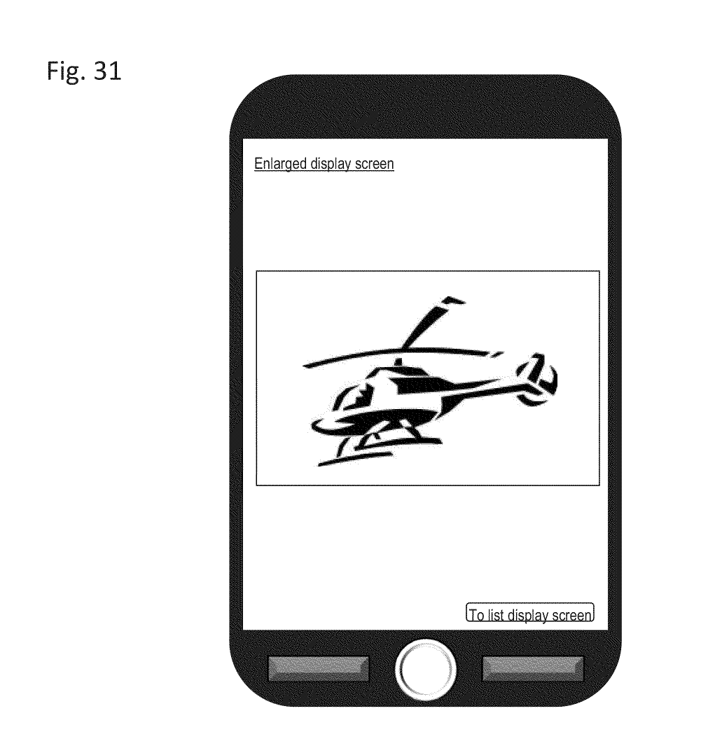

When the first network sending and receiving means 102 of the mobile terminal receives these, the summary image ID, the summary image data and the data amount flag received by the image data table 106 are stored and correlated (step S2611). The image data table 106 after step S2611 presently carried out is shown in FIG. 29 (b). The image data table 106 in the state shown in FIG. 29 (a) by the present step S2611 is changed to the state shown in FIG. 29 (b). In the new image data table 106, the data amount flag is rewritten to 2953 and a new summary image data 2952 received from the image server 160 is stored. Furthermore, the display means 110 displays an enlarged image of the image selected in step S2606 (step S2612). As a result, an example of the display means which display an enlarged image is shown in FIG. 31. When compared with FIG. 30 which is the present display, an image with a larger data amount is displayed.

Furthermore, in the explanation in the third embodiment, the mobile terminal 100 switching between the first network and the second network is explained as is shown in FIG. 2. However, in the present invention as is explained in the second embodiment, it is possible to use the mobile terminal 100 even in the case where the communication speed of a network to which the mobile terminal 100 is connected changes over time. In addition, in the explanation in the third embodiment, the function of sending an HTML code to a mobile terminal and a function of storing real image data and sending summary image data in response to a request from the mobile terminal 100 are split between the application server 140 and the image server 160 respectively. However, in the present invention, these functions may be provided in one server. In addition, in the third embodiment, the image data amount change means of the image server generates a plurality of image data in advance corresponding to a plurality of data flags respectively, these are correlated and stored in advance with a real image ID and a data amount flag and summary image data may be returned in advance in response to a request for summary image data from the mobile terminal 100. Furthermore, in the third embodiment, although an example of the mobile terminal 100 receiving an HTML code and displaying image data is explained, this terminal may be any data terminal.

Next, the effects of the third embodiment which is one embodiment of the present invention are explained. In the third embodiment, the user A requests image data to an image server via a Web browser of a mobile terminal. At this time, the mobile terminal stores a summary image data in advance, and if the communication speed of a network which can be connected to by the mobile terminal is larger than when the summary image data is received, the image server is requested to obtain a new summary image data (NO in step S2608). On the other hand, even when the mobile terminal stores summary image data, in the case where the communication speed of a network to which a mobile terminal can be connected is lower than when the summary data is received, the summary image data already stored in the mobile terminal is displayed (YES in step S2608). In this way, in the third embodiment, the following two effects can be obtained in addition to the ten effects explained in the first to second embodiments.

The eleventh effect of the present invention according to the third embodiment is that it is possible to optimize the data amount of image data sent to a mobile terminal from a server in response to the communication speed of a network even in the case where a real image data is stored in an image server and used in a Web browser of the mobile terminal. When connecting to a network with a low transfer speed, when a real image data or a summary image data with a large data amount is sent to the mobile terminal from the server, the transfer time of image data is large and convenience is lost. On the other hand, when connected to a network with high transfer speed, when summary image data with a small data amount is sent to a mobile terminal from a server, only a low quality image can be used in the mobile terminal. According to the present invention, it is possible to automatically optimize this contradictory relationship and transfer optimum image data in response to the communication speed of a network between a mobile terminal and data terminal.

The twelfth effect is that the total data amount of image data via a network is reduced compared to providing an image browsing service to the same extent as in a method using a conventional Wen service even in the case where real image data is stored in an image server and this data is used in the Web browser of a mobile terminal. Similar to the sixth effect and tenth effect described above, in the third embodiment, in the case where the communication speed of a network to which a mobile terminal is connected is low, it is possible to reduce the total amount of data via a network compared to a conventional method by reducing the data amount of summary image data sent from an image server.

1. A mobile terminal comprising:
a first sending and receiving means configured to communicate with a server via a first network;
a second sending and receiving means configured to communicate with the server via a second network having a slower speed than that of the first network;
an imaging means; and
a display means;
wherein
the imaging means generates a first real image data;
the first real image data is stored in a memory card;
a first summary image data is generated from the first real image data;
the second sending and receiving means sends via the second network and the server the first summary image data to a data terminal configured to communicate with the server;
the second sending and receiving means receives, via the second network and the server from the data terminal storing a second real image data, a second summary image data generated from the second real image data by the data terminal;
the second summary image data is stored in the memory card; and
the display means simultaneously performs a first image display for expressing the first real image data and a second image display for expressing the second summary image data.

2. A mobile terminal comprising:
a first sending and receiving means configured to communicate with a server via a first network;
a second sending and receiving means configured to communicate with the server via a second network having a slower speed than that of the first network;
an imaging means; and
a display means;
wherein
the imaging means generates a first real image data;
the first real image data is stored in a memory card;
a first summary image data is generated from the first real image data;
the second sending and receiving means sends via the second network and the server the first summary image data to a data terminal configured to communicate with the server;
the second sending and receiving means receives, via the second network and the server from the data terminal storing a second real image data, a second summary image data generated from the second real image data by the data terminal;
the mobile terminal stores the second summary image data; and
the display means simultaneously performs a first image display for expressing the first real image data and a second image display for expressing the second summary image data.

3. A mobile terminal comprising:
a first sending and receiving means configured to communicate with a server via a first network;
a second sending and receiving means configured to communicate with the server via a second network having a slower speed than that of the first network;
an imaging means; and
a display means;
wherein
the imaging means generates a first real image data;
the first real image data is stored;
a first summary image data is generated from the first real image data;
the second sending and receiving means sends via the second network and the server the first summary image data to a data terminal configured to communicate with the server;
the second sending and receiving means receives, via the second network and the server, from the data terminal storing a second real image data, a second summary image data generated from the second real image data by the data terminal;
the second summary image data is stored; and
the display means simultaneously performs a first image display for expressing the first real image data and a second image display for expressing the second summary image data.

4. The mobile terminal according to claim 1, wherein the first sending and receiving means sends the first real image data to the data terminal via the first network, and the first sending and receiving means receives and stores the second real image data from the data terminal via the first network.

5. The mobile terminal according to claim 1, wherein the display means displays a first real image storage location display which shows that the first image display expresses a real image data and the first image display wherein the first real image storage location display and the first image display are correlated, and displays a second real image storage location display which shows that the second image display expresses a real image data and the second image display wherein the second real image storage location display and the second image display are correlated.

6-11. (canceled)

12. A data terminal comprising:
a sending and receiving means capable of communicating with a mobile terminal via a first network, the mobile terminal including a first mobile terminal sending and receiving means communicating with the first network and a second mobile terminal sending and receiving means communicating with a second network having a slower speed than that of the first network; and
a display means;
wherein
a first real image data is stored;
a first summary image data is generated from the first real image data;
the sending and receiving means sends the first summary image data to the mobile terminal via the first network, the second network, and the second mobile terminal sending and receiving means;
the sending and receiving means receives, via the second mobile terminal sending and receiving means the second network, and the first network from the mobile terminal storing a second real image data, a second summary image data generated from the second real image data by the mobile terminal;
the second summary image data is stored; and
the display means simultaneously performs a first image display for expressing the first real image data and a second image display for expressing the second summary image data.

13. The data terminal according to claim 12, wherein the sending and receiving means sends the first real image data to the mobile terminal via the first network and the first mobile terminal sending and receiving means, and the sending and receiving means receives from the mobile terminal via the first mobile terminal sending and receiving means and the first network and stores the second real image data.

14-22. (canceled)

23. The mobile terminal according to claim 2, wherein the first sending and receiving means sends the first real image data to the data terminal via the first network, and the first sending and receiving means receives and stores the second real image data from the data terminal via the first network.

24. The mobile terminal according to claim 3, wherein the first sending and receiving means sends the first real image data to the data terminal via the first network, and the first sending and receiving means receives and stores the second real image data from the data terminal via the first network.
